(19) United States
(12) Patent Application Publication
(10) Pub. No.: US 2026/0252158 A1
(43) Pub. Date: Aug. 27, 2026

(54) DYNAMIC EXTRACTION MODEL GENERATION FOR COMPLEX EXTRACTIONS

(71) Applicant: Groopit, Inc., Mill Creek, WA (US)

(72) Inventors: Duane Dennis Bray, Brooklyn, NY (US); Jason Regis Burek, Seattle, WA (US); Joseph Frank Ondrus III, Fort Morgan, CO (US); Tammy Lynae Savage, Seattle, WA (US); John David Vert, Bend, OR (US)

(21) Appl. No.: 19/064,210

(22) Filed: Feb. 26, 2025

(51) Int. Cl. G06F 1/3234

(52) U.S. Cl. CPC G06F 1/3234

(57) ABSTRACT

An example method includes receiving, at a data model component, user input data associated with source information data, and determining, based at least in part on the user input data, a data field associated with the source information data. The method also includes determining a prompt comprising the data field, determining an allowed data type comprising the data field, and generating, based at least in part on the prompt and the allowed data type, an extraction definition, wherein the extraction definition is configured to generate data sets that are responsive to data fields. The method further includes sending, to an extraction component, the extraction definition, wherein the extraction component is configured to generate a data set based at least in part on the extraction definition and the source information data.

### BACKGROUND

Entities, such as corporations, organizations, and/or businesses, typically consume large quantities of complex content (e.g., documents, audio transcripts, reports, handwritten documents, spreadsheets, etc.) in order to gain valuable insights related to their business (e.g., competitor intelligence, product feedback, etc.). For example, entities may go through content such as project bids in order to learn about the pricing, job scope, timeline, etc. of a competitor for a project. Conventional methods of extracting information from content include manual review. Typically, this manual review is laborious due to both the complexity and quantity of content. For example, entities must review content for multiple different types of information and manually extract and/or summarize what is important. Further, while extraction tools may be used to summarize information associated with content, these summaries are broad, unspecific, and traditionally rely on rigid templates which yield unnecessary information.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to generate an extraction definition and process source information, according to at least some examples.

FIG. 2 illustrates an example process for extracting data from source information for single data sets, according to at least some examples.

FIG. 3 illustrates an example process for reiteratively extracting data from source information for single data sets, according to at least some examples.

FIG. 4 illustrates an example process for reiteratively extracting data from source information for multiple data sets, according to at least some examples.

FIG. 5 illustrates an example process and related user interfaces for generating extraction definitions and the use thereof, according to at least some examples.

FIG. 6 illustrates example components of the system of FIG. 1 that generates an extraction definition and processes source information, according to at least some examples.

FIG. 7 illustrates a flow diagram of an example process for the generation of a machine learning model and the use of the same, according to at least some examples.

FIG. 8 illustrates a flowchart outlining an example method for dynamic extraction model generation for complex extractions, according to at least some examples.

FIG. 9 illustrates a flowchart outlining an example method for complex extraction and analytics for content insights, according to at least some examples.

### DETAILED DESCRIPTION

This application describes systems and techniques for extraction definition (e.g., extraction data model) generation and complex extraction via an extraction system and/or service (hereinafter “extraction system”). For example, an extraction system may receive user input data that has been provided by and/or received from a user and/or entity, where the user input may be associated with source information. For example, user input data may indicate source information data such as a digital document (e.g., reports, transcripts, logs, notes, etc.), platform data (e.g., Customer Relationship Management (CRM) data), live audio data (e.g., voice), recorded audio data, communication data (e.g., unstructured conversation included in messages, emails, etc.), video data, text (e.g., handwritten, computer-generated, etc.), and/or the like. When user input data is received by the extraction system, the extraction system may further be configured to determine one or more data fields to be used in combination with source information (e.g., the data fields may be usable as input and/or a data container in order to extract from the source information data). In some instances, the data field may be determined based on user input data. Additionally, or alternatively, the extraction system may be configured to determine, automatically (e.g., without user input), the one or more data fields. In some instances, the data field may be executable in a computer-centric environment and determined from a multitude of data fields such that the extraction system processes a limited amount of the multitude of data fields in a manner that saves processing power. Further, the extraction system may determine a prompt and data type that may comprise the data field. For example, a prompt may include a natural language explanation of the contents to be captured within the data field. Additionally, or alternatively, the prompt may be executable in a computer-centric environment and determined from a multitude of prompts such that the extraction system processes a limited amount of the multitude of prompts in a manner that saves processing power. A data type may include allowed types of information for populating the data field (e.g., tags, lists, tables, text, numbers, dates, etc.) and may also be executable in a computer-centric environment and determined from a multitude of data types such that the extraction system processes a limited amount of the multitude of data types in a manner that saves processing power. Based on the prompt and/or data type associated with one or more data fields, the extraction system may generate an extraction definition, wherein the extraction definition is configured to generate data sets that are responsive to data fields. For example, an extraction definition may be used, or work in combination with, one or more components (e.g., machine learning component) of the extraction system in order to generate one or more extracted data sets from the source information. The extraction definition may be sent to an extraction component of the system, where the extraction component is configured to generate a data set based at least in part on the extraction definition and the source information, and requiring a smaller amount of storage than a data set that is not based on the extraction definition.

In another example, the extraction system may be configured to process source information according to the extraction definition. For example, the extraction system may receive source information from a user (e.g., individual, business, entity, enterprise, etc.) as well as an extraction definition associated with the source information. In some examples, source information and/or an extraction definition may be pushed to the extraction system automatically. The extraction system may be configured to determine extraction processing instructions (e.g., text-based instructions for subsequent processing by a machine learning model) and return instructions (e.g., text-based instructions for returning the extracted data set from the source information and by the machine learning model). The extraction processing instructions and/or extraction return instructions may be executable in a computer-centric environment, and determined from a multitude of extraction processing instructions and/or extraction return instructions such that the extraction component processes a limited amount of the multitude of extraction processing instructions and/or extraction return instructions in a manner that saves processing power. The extraction system may also be configured to generate an extraction prompt based on the extraction processing instructions and return instructions. Further, the extraction system may use, or work in combination with, the machine learning model trained to determine data sets associated with content of the source information data in order to determine a data set extracted from the source information and using the extraction prompt. For example, the data set may include specific information extracted from the source information and pertaining to, or populating, one or more data fields based on data types, data formats, data values, etc. indicated by the extraction definition (e.g., an extracted data set). Additionally, or alternatively, the extraction system may perform one or more validation operations associated with the extracted data set. For example, the extraction system may remove extraneous information provided by the machine learning model and/or map the extracted data set to the extraction definition (e.g., mapping allowed data types, formats, values, etc.). The validated extracted data set may require a smaller amount of storage than an unvalidated data set when the one or more validation operations are not performed. The validated extracted data set may comprise extraction output data, which may be included in a representation (e.g., graphical representation) and/or routed based on one or more attributes of the extraction output data.

Traditionally, as discussed above, entities, such as corporations, organizations, and/or businesses, typically consume large quantities of complex content (e.g., documents, transcripts, reports, etc.) in order to gain valuable insights related to their business (e.g., competitor intelligence, product feedback, etc.). For example, entities may go through content such as project bids in order to learn about the pricing, job scope, timeline, etc. of a competitor for a project. Conventional methods of extracting information from content include manual review. Typically, this manual review is laborious, due to both the complexity and quantity of content. For example, entities must review content for multiple different types of information and manually extract and/or summarize what is important. Further, while extraction tools may be used to summarize information associated with content, these summaries are broad, unspecific, and traditionally rely on rigid templates which yield unnecessary information.

Described herein are, at least in part, techniques including the generation of extraction definitions and use thereof, where an extraction definition may be usable to extract specific information (e.g., a data set) from a source based at least in part on prompts, data types, data formats, etc. that may comprise an extraction definition. The techniques described herein may be applicable in various scenarios, including scenarios where an entity would like to gain insights regarding particular information from one or more sources. Various examples of the present disclosure include systems, methods, and non-transitory computer-readable media of an extraction system.

A user of an extraction system may include an individual user, agent, business, corporation, entity, enterprise, and/or the like (collectively referred to as “entity”). For example, the entity may use the extraction system to gain insights from source information data. In some examples, the techniques described herein with respect to the extraction system may be performed, in part or entirely, by an artificial intelligence (AI) agent. In order to gain insights from source information data, the extraction system may use, or work in combination with, one or more components (e.g., a data model component) in order to determine the extraction definition. As described in more detail below, extraction definitions may include data fields including prompts and allowed, or pre-defined, data types, data values, etc. The extraction system may use, or work in combination with, the extraction definition in order to extract information, or one or more extracted data sets, from source information data.

As described above, the extraction definition may include a data field, prompt, data type, data formats, data values, and/or the like. A data field may represent a container for particular information to be extracted and/or determined from source information data. Further, the data field may be executable in a computer-centric environment and determined from a multitude, or group, of data fields such that the extraction system (e.g., an extraction component) processes a limited amount of the group of data fields. This way, the extraction system may require the deployment of fewer computing resources (e.g., processing power) by processing a limited amount of the group of data fields. A prompt associated with a data field may include a natural language explanation of the particular attribute, property, characteristics, etc. to be included as part of the data field. By way of example, and not limitation, a prompt may include and/or indicate competitive pricing terms, a price, issue date, competitor, strengths, weaknesses, product feedback, scores, etc. Further, the prompt may be executable in a computer-centric environment and determined from a multitude, or group, of prompts such that the extraction system processes a limited amount of the group of prompts. This way, the extraction system may require the deployment of fewer computing resources (e.g., processing power) by processing a limited amount of the group of prompts. A data type associated with a data field may include the kind, or type, of information that is allowed to populate the data field (e.g., tags, lists, tables, text, numbers, dates, and/or other information usable by the extraction system to determine how source information data should be processed, extracted from, etc.). Further, the data type may be executable in a computer-centric environment and determined from a multitude, or group, of data types such that the extraction system processes a limited amount of the group of data types. This way, the extraction system may require the deployment of fewer computing resources (e.g., processing power) by processing a limited amount of the group of data types. A data format associated with a data field may include a structure or presentation style associated with a data type that is permitted, or allowed, to populate the data field (e.g., percentage, currency, date only, date and time, and/or the like). An allowed data value associated with a data field may include a pre-defined value or set of values that may be included in a data field. For example, for a data field with a tag data type, the extraction definition may include allowed data values indicating that the data field is to include one of a set of defined competitor tag (e.g., “Acme Corp.,” “XYZ Widget Co.,” “Blackacre Holdings,” etc.).

By way of example, and not limitation, an extraction definition may include a single data field with a prompt of “Competitive Pricing Terms” and a “text” data type. Additionally, or alternatively, an extraction definition may include multiple data fields. For example, the extraction definition may include a first data field with the prompt of “Competitive Pricing Terms” and a “text” data type, a second data field with the prompt of “Price” and a “number” data type, and/or a third data field with the prompt of “Competitor,” a “tag” data type, and an allowed data value (e.g., a tag corresponding to a competitor from a group of tagged competitors such as “Acme Corp.,” “XYZ Widget Co.,” “Blackacre Holdings,” etc.). An extraction definition may include any quantity of data fields. It is to be appreciated that the extraction definition may be usable to obtain objective information (e.g., pricing information) and/or subjective information (e.g., information on the strengths and weaknesses of source information data, such as a project proposal). By way of example, and not limitation, a data field with a text data type may include a prompt such as “review the proposal and identify the bidder's win themes. A win theme is described as the feature of capability the bidder has that allows them to solve the customer's issues. Describe the top five win themes in the proposal.”

In some instances, the extraction definition may be determined based on user input. User input data may indicate natural language instructions, a selection of allowed data types, data formats, data values, and/or the like. For example, user input data (e.g., from an administrator associated with an entity) may be received at a data model component and indicate instructions (e.g., selecting a competitor) associated with a data field, a selection of one or more allowed data types (e.g., tag field,), a selection of allowed data values, and/or the like. Based on the user input data, an extraction definition may be created that is configured to extract tailored and particular information from source information data.

Additionally, or alternatively, the extraction system may be configured to determine the extraction definition automatically (e.g., without user input, such as using an artificial intelligence (AI) agent). For example, the extraction system may use, or work in combination with, a machine learning component in order to determine which data fields, prompts, data types, and/or data values are to be included as part of an extraction definition (e.g., what is to be extracted). For example, a machine learning component may be configured to determine one or more attributes associated with the entity (e.g., best practices, guidelines, etc.). Based on the one or more attributes, the machine learning component may be configured to determine a comparison between the one or more attributes and a constructed data model (e.g., extraction definition). The comparison between the one or more attributes and the extraction definition may be used by the machine learning component to identify changes to extraction definition, a different extraction definition entirely, etc. For example, the machine learning component may determine a comparison between guidelines associated with the entity (e.g., what information the entity is focused on obtaining) and the extraction definition, and may identify changes to the extraction definition to better align with the guidelines. In some instances, the extraction system may use, or work in combination with, the machine learning component in order to determine which data fields, prompts, data types, and/or data values are to be included, or allowed, as part of the extraction definition based on source information data. For example, based on the source information data, the machine learning component may identify and/or determine key attributes (e.g., problems, feedback, etc.) associated with the source information data. Based on the key attributes associated with the source information data, an extraction definition may be determined (e.g., an extraction definition configured to extract and/or analyze information pertaining to the key attributes).

The extraction system may be configured to extract information (e.g., data sets) from source information data using the extraction definition described above. For example, a component of the extraction system (e.g., an extraction component) may receive the extraction definition. Additionally, or alternatively, the extraction system may receive source information data. Source information data may include, but is not limited to, data associated with a document, PDF, webpage, messaging platforms, customer relationship management (CRM) platforms, audio data (e.g., live and/or recorded audio data), communication data (e.g., unstructured conversation included in messages, emails, etc.), video data, text (e.g., handwritten, computer-generated, etc.) and/or the like. In some instances, the source information data may be received via user input. Additionally, or alternatively, source information data may be received via application programming interfaces (APIs) and API calls, and/or other means for pushing and/or pulling source information data.

The extraction system may extract one or more data sets according to the extraction definition upon receipt of source information data. This way, the extraction system may generate one or more data sets requiring a smaller amount of computing resources (e.g., storage) than data sets that are not based on an extraction definition. Additionally, or alternatively, the extraction system may be configured to trigger the extraction of one or more data sets based on one or more conditions. Triggers may include a particular term, key word, number, name, and/or the like. By way of example, and not limitation, an indication of competitor in a messaging channel (e.g., “Acme Corp”) may trigger the extraction of one or more data sets according to the extraction definition, where the source information data may at least partially include the contents of the messaging channel. In another example, the submission of PDF including a project bid over a particular value (e.g., $5,000) may trigger the extraction of one or more data sets according to the extraction definition, where the source information data may at least partially include the contents of the PDF. It is to be appreciated that the extraction system may be configured to trigger the use of multiple and/or different extraction definitions, as well as using multiples of and/or different source information data. In some instances, one or more triggers for different extraction definitions and/or source information data may occur simultaneously. Additionally, or alternatively, the extraction system may be configured to trigger the extraction of one or more data sets according to the extraction definition based on conditions such as a change in source information data, new source information data, etc. For example, source information data may indicate a new document in a particular folder (e.g., a watched folder), and in turn, trigger the extraction of one or more data sets according to the extraction definitions from the new document. It is to be appreciated that the triggering of data set extractions may be based on user input, API calls, machine learning, and/or the like.

Upon receipt of source information data, the occurrence of a trigger event, and/or the like, the extraction system may be configured to extract and/or determine a data set from source information data according to the techniques described herein. For example, source information data (e.g., a document in a digital format) may be received, detected, etc. by a component associated with the extraction system (e.g., extraction component). The extraction definition may also be received by the extraction system or previously determined by the extraction system. In some instances, the extraction system may be configured to apply one or more transformations to the extraction definition. For example, the extraction system may determine extraction processing instructions and/or extraction return instructions based on the extraction definition. The extraction processing instructions may be executable in a computer-centric environment, such as the computer-centric environment of the extraction system. For example, the extraction definition may include natural language associated with one or more data fields (e.g., specifying allowed data types, data format, allowed data values, etc.). In some instances, the extraction system may determine a first representation of the extraction definition that may be usable by a machine learning component of the extraction system. For example, the first representation of the extraction definition may include extraction processing instructions. The extraction processing instructions may include text-based instructions (e.g., what data to look for, how to format that data, calculations that need to be performed, value types, available tags, etc.) that are usable by the machine learning component in order to extract information (e.g., extracted data sets) according to the extraction definition. In some instances, determining the extraction processing instructions may include processing the extraction definition to JavaScript Object Notation (JSON), TypeScript schema, and/or other types of formats, programming languages, etc. Additionally, or alternatively, the extraction system may determine the extraction processing instructions from a multitude, or group, of extraction processing instructions. By way of example, and not limitation, the group of extraction processing instructions may each be associated with text-based instructions associated with different extraction definitions (e.g., extraction processing instructions for extracting different data types, data formats, data values, etc.). This way, the extraction system may require the deployment of fewer computing resources (e.g., processing power) by processing a limited amount of the group of extraction processing instructions.

Additionally, or alternatively, the extraction system may determine a second representation associated with the extraction definition that may be usable by the machine learning component of the extraction system. For example, the second representation associated with the extraction definition may include extraction return instructions. For example, the extraction system may determine extraction processing instructions and/or extraction return instructions based on the extraction definition. The extraction processing instructions may be executable in a computer-centric environment, such as the computer-centric environment of the extraction system. The extraction return instructions may include text-based instructions (e.g., specifications such as the format, values, etc.) that are usable by the machine learning component when outputting an extracted data set. In some instances, the extraction return instructions may instruct the machine learning component to return the outputted data set in JSON, TypeScript, and/or other types of formats, programming languages, etc. Additionally, or alternatively, the extraction system may determine the extraction return instructions from a multitude, or group, of extraction return instructions. By way of example, and not limitation, the group of extraction return instructions may each be associated with text-based instructions associated with different extraction definitions (e.g., extraction return instructions for outputting different data types, data formats, data values, etc.). This way, the extraction system may require the deployment of fewer computing resources (e.g., processing power) by processing a limited amount of the group of extraction return instructions.

Based on the extraction processing instructions and/or extraction return instructions, the extraction system may be configured to determine an extraction prompt. For example, the extraction prompt may include the extraction processing instructions, the extraction return instructions, source information data, and/or other instructions. The extraction prompt may then be usable by the machine learning component in order to extract one or more data sets from the source information data according to the extraction definition. For example, based on the prompt, the machine learning component may analyze the source information data and extract data (e.g., an extracted data set) that corresponds to the extraction definition and/or extraction processing instructions (e.g., populates the defined data field). By way of example, and not limitation, an extraction definition may be configured to extract competitive intel (e.g., the store number associated with a competitor, price of a product, etc.) for source information data, such as a competitive pricing sheet. Based on the extraction prompt generated from the extraction definition, and including extraction processing instructions and/or extraction return instructions, the machine learning component may execute an extraction of a data set, the data set including information corresponding to the competitive intel defined by the extraction definition. In some instances, the machine learning component may be configured to execute the extraction of a data set that only partially corresponds to the extraction definition. By way of example, and not limitation, the machine learning component may otherwise “leave blank” certain data fields (e.g., refrain from populating a defined data field). In other words, the machine learning component may refrain from including a portion of the source information data as corresponding to a data field defined by the extraction definition in instances where the machine learning component is uncertain about the data to extract according to the extraction definition. For example, the machine learning component may determine a confidence associated with one or more portions of the extracted data set. If the confidence is below a confidence threshold, the machine learning component may refrain from including one or more portions of the source information data as corresponding to a respective data field. Additionally, or alternatively, the machine learning component may “leave blank” certain data fields when there is no match between the source information data and the extraction definition (e.g., between the source information data and one or more data fields of the extraction definition). By way of example, and not limitation, there may be no match between the source information data and an allowed data type for a data field of an extraction definition.

In some instances, the extraction system may be configured to perform one or more validation operations on the data set extracted by the machine learning component. For example, the extraction system may use, or work in combination with, a validation component to perform validation operations. Validation operations may include validating the extracted data set to remove extraneous information (e.g., to determine a specified extracted data set), map the extracted data set to the extraction definition (e.g., to determine a mapped extracted data set), and/or validate the specified and mapped extracted data set to one or more requirements (e.g., to determine a validated extracted data set).

The validation component may determine a specified extracted data set by removing extraneous information from the extracted data set, such as invalid data. Invalid data that may be removed from an extracted data set may include data not pertaining to the extraction definition, not an allowed data type, data format, data value, etc. By way of example, and not limitation, the validation component may determine a specified extracted data set by removing invalid JSON formatting that may not correspond to the extraction definition, such as removing from the extracted data set (e.g., a body of content) any information added by the machine learning component (e.g., an introductory paragraph, extraneous comments, etc.). This way, a specified extracted data set may be determined. Additionally, or alternatively, the validation component may determine a mapped extracted data set from the specified extracted data set. The validation component may determine the mapped extracted data set by mapping the specified extracted data set to the extraction definition (e.g., using field identifiers). Additionally, or alternatively, the validation component may validate the mapped extracted data set to determine a validated extracted data set. The validation component may determine the validated extracted data set by determining a comparison between the mapped extracted data set and one or more attributes of the extraction definition. For example, the validation component may determine whether the mapped extracted data set includes the allowed data types, formats, values, etc. defined by the extraction definition. By way of example, and not limitation, the extraction definition may include attributes such as an indication of a certain quantity of tags with allowed, or pre-defined, data values (e.g., tags indicating a competitor such as “Acme Corp.,” “XYZ Widget Co.,” and/or “Blackacre Holdings”). The validation component may then determine whether the mapped extracted data set in fact includes one of the allowed data values defined by the extraction definition.

Continuing from the example above, if the mapped extracted data set includes an indication of a competitor tag such as “Greenacre Holdings,” the mapped extracted data set may not be validated. In instances where a mapped extracted data set is not validated, the extraction system may be configured to discard the extracted data set, and perform one or more remedial actions (e.g., re-running the extraction, etc.). In instances where a mapped extracted data set is validated, the validation component generates a validated extracted data set, which may be output by the extraction system. By generating and/or using the validated extracted data set, the extraction system may require the deployment of fewer computing resources (e.g., storage) by outputting only the validated extracted data set as opposed to an unvalidated data set.

The output data (e.g., the validated extracted data set) may be routed by the extraction system based on one or more attributes of the output data. For example, the extraction system may determine one or more attributes of the output data (e.g., the amount of output data, the type of output data, the subject matter of the output data, the source information data from which the output data was determined, etc.). Based on the one or more attributes of the output data may be routed such that the output data may be displayed at a user interface, accessible via an API, stored locally and/or cloud-based, etc. In some instances, based on the one or more attributes of the output data, the output data may be routed to a user associated with the source information data and/or extraction definition data. Additionally, or alternatively, the extraction system may be configured to output the validated extracted data set to particular users, systems, etc. based on the one or more attributes of the output data. For example, the validated extracted data set may include an indication of escalated data for the entity (e.g., an indication that a product of the entity is defective, causing harm, etc.). Based on this indication, the extraction system may determine that the validated extracted data set should be escalated to a particular user, system, etc. (e.g., the head of product development), and output the validated extracted data set accordingly. Additionally, or alternatively, the output data may be delivered by the extraction system to a user (e.g., the user who requested the validated extracted data set), such as at a user interface, accessible via an API, stored locally and/or cloud-based, etc.

The techniques described herein improve the function of data extraction and processing. For example, in order to gain particular insights with respect to a business, industry, service, etc., an entity must manually go through large amounts of source documents (e.g., annual reports, transcripts, etc.), which may be resource-intensive and inefficient. While some extractive tools have been implemented, entities are unable to use these tools to precisely define the information they wish to extract, as well as automate the extraction. Further, traditional extractive tools rely on rigid templates that may yield unnecessary information and do not accommodate the varied needs of entity decision-makers. Accordingly, the techniques described herein may increase efficiencies around the extraction of information across diverse formats, sources, enterprise data systems, CRMs, emails, documents, web pages, video, audio, and/or the like, and thus enabling entities to extract large amounts of tailored and specific data, as well as automate processes where the extraction of data may be performed iteratively and/or in-real time. Additionally, while the described data extraction techniques may cause productivity gains, the techniques may also improve the utilization of computing resources, increase scalability, and reduce entity costs.

Some of the techniques described herein are with reference to data extraction from source information data. However, the techniques are generally applicable to any type of data extraction. Additionally, or alternatively, the techniques described herein are with reference to source information data (e.g., documents, web pages, etc.). However, the techniques are generally applicable to any environment, platform, etc.

These and other aspects are described further below with reference to the accompanying drawings. The drawings are merely example implementations and should not be construed to limit the scope of the claims. For example, while examples are illustrated in the context of a user interface for a mobile device, the techniques may be implemented using any computing device and the user interface may be adapted to the size, shape, and configuration of the particular computing device.

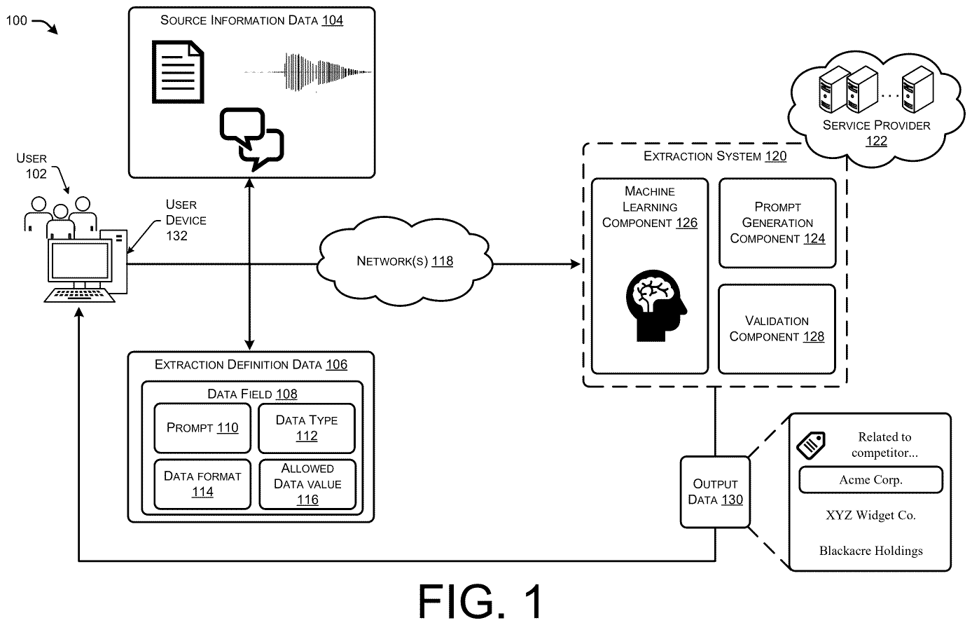

FIG. 1 is a schematic view of an example system 100 usable to generate an extraction definition (e.g., extraction definition data 106) and process source information (e.g., source information data), according to at least some examples.

The user 102 of the extraction system 120 may include an individual user, agent, business, corporation, entity, enterprise, and/or the like (collectively referred to as “user 102”). For example, the user 102 may use the extraction system 120 to gain insights from source information data 104. As illustrated, users 102 may be associated with user device(s) 132 that enables the user 102 to share source information data 104 and/or extraction definition data 106 with the extraction system 120. In some examples, the user device(s) 132 may include desktop computers, laptop computers, tablet computers, mobile devices (e.g., smart phones or other cellular or mobile phones, mobile gaming devices, portable media devices, etc.), or other suitable computing devices. The user device(s) 132 may execute one or more client applications, such as a web browser (e.g., Microsoft Windows Internet Explorer, Mozilla Firefox, Apple Safari, Google Chrome, Opera, etc.) and/or a native or special-purpose client application (e.g., social media applications, messaging applications, email applications, games, etc.), to access and view content over the network 118.

In some examples, a service provider 122 of the extraction system 120 may be associated with a cloud provider network. In other instances, however, the service provider 122 may be associated with an on-premises network, a private network of a corporation, and/or any other type of network or combination thereof. The extraction system 120 may be included in, or associated with, the service provider 122 and its respective network. User device(s) 132 may communicate with the service provider 122 over network(s) 118, such as Internet. In some instances, the network(s) 118 may generally comprise one or more networks implemented by any viable communication technology, such as wired and/or wireless modalities and/or technologies. The network(s) 118 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the user device(s) 132 may access the extraction system 120.

In order to gain insights from source information data 104, the extraction system 120 may use, or work in combination with, one or more components (e.g., a data model component) in order to determine the extraction definition data 106. For example, a data model may be used to build extraction definition data 106. As described in more detail below, extraction definition data 106 may include data field 108, prompt 110, data type 112, data format 114, and/or allowed data value 116. The extraction system 120 may use, or work in combination with, the extraction definition data 106 in order to extract information, or one or more extracted data sets, from source information data 104.

As described above, the extraction definition data 106 may include a data field, prompt, data type, data formats, data values, and/or the like. A data field 108 may represent and/or place hold for a particular attribute, property, characteristic, etc. to be extracted from source information data 104. A prompt 110 may include a natural language explanation of the particular attribute, property, characteristics, etc. to be included as part of the data field 108. By way of example, and not limitation, a prompt 110 may include and/or indicate competitive pricing terms, a price, issue date, competitor, strengths, weaknesses, product feedback, scores, etc. A data type 112 associated with a data field 108 may include the kind, or category, of information associated with the data field 108 (e.g., tags, lists, tables, text, numbers, dates, and/or other information usable by the extraction system 120 to determine how source information data 104 should be processed or displayed). A data format 114 associated with a data field 108 may include a structure or presentation style associated with a data type (e.g., percentage, currency, date only, date and time, and/or the like). An allowed data value 116 associated with a data field 108 may include a pre-defined value or set of values that may be included in a data field 108. For example, for a data field 108 with a tag data type, the extraction definition data 106 may include data values such as explicitly-named competitor tags (e.g., “Acme Corp.,” “XYZ Widget Co.,” “Blackacre Holdings,” etc.). An extraction definition data 106 may include any quantity of data fields 108. It is to be appreciated that the extraction definition data 106 may include objective information (e.g., pricing information) and/or subjective information (e.g., information on the strengths and weaknesses of source information data 104, such as a project proposal).

The extraction system 120 may be configured to extract information (e.g., data sets) from source information data 104 using the extraction definition data 106 described above. For example, a component of the extraction system 120 (e.g., an extraction component) may receive the extraction definition data 106. Additionally, or alternatively, the extraction system 120 may receive source information data 104. Source information data 104 may include data associated with a document, PDF, webpage, messaging platforms, customer relationship management (CRM) platforms, audio data (e.g., live and/or recorded audio data), and/or the like. In some instances, the source information data 104 may be received via user input. Additionally, or alternatively, source information data 104 may be received via application programming interfaces (APIs) and API calls.

The extraction system 120 may extract one or more data sets from source information data 104 according to the extraction definition data 106 upon receipt of source information data 104, a change in source information data 104, and/or the determination of extraction definition data 106. For example, source information data 104 (e.g., a document in a digital format) may be received, detected, etc. by a component associated with the extraction system 120 (e.g., extraction component). The extraction definition data 106 may also be received by the extraction system 120 or previously determined by the extraction system 120. In some instances, the extraction system 120 may be configured to apply one or more transformations to the extraction definition data 106. For example, the extraction system 120 may determine extraction processing instructions and/or extraction return instructions based on the extraction definition data 106. In some instances, the extraction system 120 may determine a first representation of the extraction definition data 106 that may be usable by a machine learning component 126 of the extraction system 120. For example, the first representation of the extraction definition data 106 may include extraction processing instructions. The extraction processing instructions may include text-based instructions (e.g., what data to look for, how to format that data, calculations that need to be performed, value types, available tags, etc.) that are usable by the machine learning component 126 in order to extract information (e.g., extracted data sets) according to the extraction definition data 106. In some instances, determining the extraction processing instructions may include processing the extraction definition data 106 to JavaScript Object Notation (JSON), TypeScript schema, and/or other types of formats, programming languages, etc.

Additionally, or alternatively, the extraction system 120 may determine a second representation associated with the extraction definition data 106 that may be usable by the machine learning component 126 of the extraction system 120. For example, the second representation associated with the extraction definition data 106 may include extraction return instructions. The extraction return instructions may include text-based instructions (e.g., specifications such as the format, values, etc.) that are usable by the machine learning component 126 when outputting an extracted data set. In some instances, the extraction return instructions may instruct the machine learning component 126 to return the outputted data set in JSON, TypeScript, and/or other types of formats, programming languages, etc. Based on the extraction processing instructions and extraction return instructions, prompt generation component 124 of the extraction system 120 may be configured to determine an extraction prompt. For example, the extraction prompt may include the extraction processing instructions, the extraction return instructions, source information data 104, and/or other instructions. The extraction prompt may then be usable by the machine learning component 126 in order to extract one or more data sets from the source information data 104 according to the extraction definition data 106. For example, based on the prompt, the machine learning component 126 may analyze the source information data 104 and extract data (e.g., an extracted data set) that corresponds to the extraction definition data 106 and/or extraction processing instructions.

In some instances, the extraction system 120 may be configured to perform one or more validation operations on the data set extracted by the machine learning component 126. For example, the extraction system 120 may use, or work in combination with, a validation component 128 to perform validation operations. Validation operations may include validating the extracted data set to remove extraneous information (e.g., to determine a specified extracted data set), map the extracted data set to the extraction definition data 106 (e.g., to determine a mapped extracted data set), and/or validate the specified and mapped extracted data set to one or more requirements (e.g., to determine output data 130).

The validation component 128 may determine a specified extracted data set by removing extraneous information from the extracted data set, such as invalid data. Invalid data that may be removed from an extracted data set may include data not pertaining to the extraction definition data 106, not in the valid format, etc. By way of example, and not limitation, the validation component 128 may determine a specified extracted data set by removing invalid JSON formatting that may not correspond to the extraction definition data 106, such as removing from the extracted data set (e.g., a body of content) any information added by the machine learning component 126 (e.g., an introductory paragraph, extraneous comments, etc.). This way, a specified extracted data set may be determined. Additionally, or alternatively, the validation component 128 may determine a mapped extracted data set from the specified extracted data set. The validation component 128 may determine the mapped extracted data set by mapping the specified extracted data set to the extraction definition data 106 (e.g., using field identifiers). Additionally, or alternatively, the validation component 128 may validate the mapped extracted data set to determine a validated extracted data set (e.g., output data 130). The validation component 128 may determine the validated extracted data set by determining a comparison between the mapped extracted data set and one or more attributes of the extraction definition data 106. For example, the validation component 128 may determine whether the mapped extracted data set includes the data types, formats, values, etc. provided by the extraction definition data 106. By way of example, and not limitation, the extraction definition data 106 may include attributes such as an indication of a certain quantity of tags with pre-defined data values (e.g., tags of different competitors such as “Acme Corp.,” “XYZ Widget Co.,” and/or “Blackacre Holdings”). The validation component 128 may then determine whether the mapped extracted data set in fact includes one of the data values defined by the extraction definition data 106. Once an extracted data set has been validated, output data 130 comprising the validated extracted data may be provided to the user 102. For example, the output data 130 may be displayed in a representation (e.g., a graphical representation) at a user interface of the user device 132, accessible via an API, stored locally and/or cloud-based, etc.

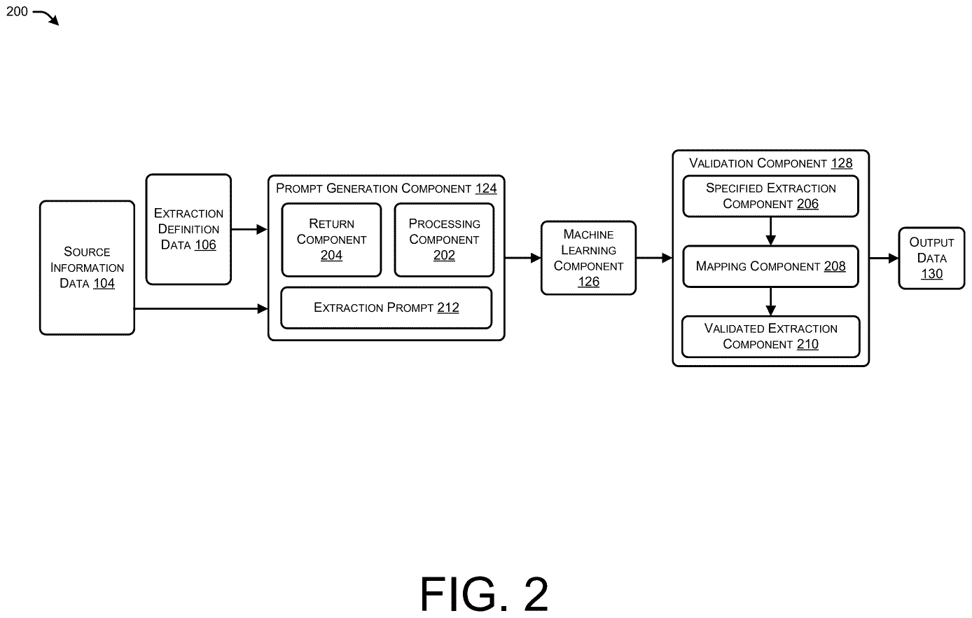

FIG. 2 illustrates an example process 200 for extracting data from source information (e.g., source information data 104) for single data sets, according to at least some examples.

For example, a component of the extraction system (e.g., an extraction component of extraction system 120) may receive the extraction definition data 106. Additionally, or alternatively, the extraction system may receive source information data 104. Source information data 104 may include data associated with a document, PDF, webpage, messaging platforms, customer relationship management (CRM) platforms, audio data (e.g., live and/or recorded audio data), and/or the like. In some instances, the source information data 104 may be received via user input. Additionally, or alternatively, source information data 104 may be received via application programming interfaces (APIs) and API calls.

The extraction system may extract a data set according to the extraction definition data 106 upon receipt of source information data 104. Additionally, or alternatively, as described above, the extraction system may be configured to trigger the extraction of a data set based on one or more conditions. Based on the occurrence of a trigger event, the extraction system may be configured to extract a data set from source information data 104 according to the techniques described herein. For example, source information data 104 (e.g., a document in a digital format) may be received, detected, etc. by a component associated with the extraction system. The extraction definition data 106 may also be received by the extraction system or previously determined by the extraction system. In some instances, the extraction system may be configured to apply one or more transformations to the extraction definition data 106. For example, a processing component 202 of the extraction system may determine extraction processing instructions based on the extraction definition data 106. Additionally, or alternatively, a return component 204 of the extraction system may determine extraction return instructions based on the extraction definition data 106. As described above, the extraction definition data 106 may include natural language associated with one or more data fields (e.g., specifying data types, data format, data values, etc.). In some instances, the processing component 202 may determine a first representation of the extraction definition data 106 that may be usable by a machine learning component 126 of the extraction system. For example, the first representation of the extraction definition data 106 may include extraction processing instructions. The extraction processing instructions may include text-based instructions (e.g., what data to look for, how to format that data, calculations that need to be performed, value types, available tags, etc.) that are usable by the machine learning component 126 in order to extract information (e.g., and extracted data set) according to the extraction definition data 106. In some instances, determining the extraction processing instructions may include processing the extraction definition data 106 to JavaScript Object Notation (JSON), TypeScript schema, and/or other types of formats, programming languages, etc.

Additionally, or alternatively, the return component 204 may determine a second representation associated with the extraction definition data 106 that may be usable by the machine learning component 126 of the extraction system. For example, the second representation associated with the extraction definition data 106 may include extraction return instructions. The extraction return instructions may include text-based instructions (e.g., specifications such as the format, values, etc.) that are usable by the machine learning component 126 when outputting an extracted data set. In some instances, the extraction return instructions may instruct the machine learning component 126 to return the outputted data set in JSON, TypeScript, and/or other types of formats, programming languages, etc. Based on the extraction processing instructions and extraction return instructions, the prompt generation component 124 of the extraction system may be configured to determine an extraction prompt 212. For example, the extraction prompt 212 may include the extraction processing instructions, the extraction return instructions, source information data 104, and/or other instructions. The extraction prompt 212 may then be usable by the machine learning component 126 in order to extract a data set from the source information data 104 according to the extraction definition data 106. For example, based on the prompt, the machine learning component 126 may analyze the source information data 104 and extract data (e.g., an extracted data set) that corresponds to the extraction definition data 106 and/or extraction processing instructions. By way of example, and not limitation, an extraction definition data 106 may be configured to extract competitive intel (e.g., the store number associated with a competitor, price of a product, etc.) for source information data 104, such as a competitive pricing sheet. Based on the extraction prompt 212 generated from the extraction definition data 106, and including extraction processing instructions and/or extraction return instructions, the machine learning component 126 may execute an extraction of a data set, the data set including information corresponding to the competitive intel defined by the extraction definition data 106.

In some instances, the extraction system may be configured to perform one or more validation operations on the data set extracted by the machine learning component 126. For example, the extraction system may use, or work in combination with, a validation component 128 to perform validation operations. Validation operations may include validating the extracted data set to remove extraneous information (e.g., to determine a specified extracted data set), map the extracted data set to the extraction definition data 106 (e.g., to determine a mapped extracted data set), and/or validate the specified and mapped extracted data set to one or more requirements (e.g., to determine a validated extracted data set).

The specified extraction component 206 of the validation component 128 may determine a specified extracted data set by removing extraneous information from the extracted data set, such as invalid data. Invalid data that may be removed from an extracted data set may include data not pertaining to the extraction definition data 106, not in the valid format, etc. By way of example, and not limitation, the specified extraction component 206 may determine a specified extracted data set by removing invalid JSON formatting that may not correspond to the extraction definition data 106, such as removing from the extracted data set (e.g., a body of content) any information added by the machine learning component 126 (e.g., an introductory paragraph, extraneous comments, etc.). This way, a specified extracted data set may be determined. Additionally, or alternatively, the mapping component 208 of the validation component 128 may determine a mapped extracted data set from the specified extracted data set. The mapping component 208 may determine the mapped extracted data set by mapping the specified extracted data set to the extraction definition data 106 (e.g., using field identifiers). Additionally, or alternatively, the validated extraction component 210 of the validation component 128 may validate the mapped extracted data set to determine a validated extracted data set. The validated extraction component 210 may determine the validated extracted data set by determining a comparison between the mapped extracted data set and one or more attributes of the extraction definition data 106. For example, the validated extraction component 210 may determine whether the mapped extracted data set includes the data types, formats, values, etc. provided by the extraction definition data 106. By way of example, and not limitation, the extraction definition data 106 may include attributes such as an indication of a certain quantity of tags with pre-defined data values (e.g., tags of different competitors such as “Acme Corp.,” “XYZ Widget Co.,” and/or “Blackacre Holdings”). The validated extraction component 210 may then determine whether the mapped extracted data set in fact includes one of the data values defined by the extraction definition data 106.

Continuing from the example above, if the mapped extracted data set includes an indication of a competitor tag such as “Greenacre Holdings,” the mapped extracted data set may not be validated. In instances where a mapped extracted data set is not validated, the extraction system may be configured to discard the extracted data set, and perform one or more remedial actions (e.g., re-running the extraction, etc.). In instances where a mapped extracted data set is validated, the validation component 128 generates a validated extracted data set, which may be output by the extraction system (e.g., output data 130). The output data 130 (e.g., the validated extracted data set) may be displayed at a user interface, accessible via an API, stored locally and/or cloud-based, etc.

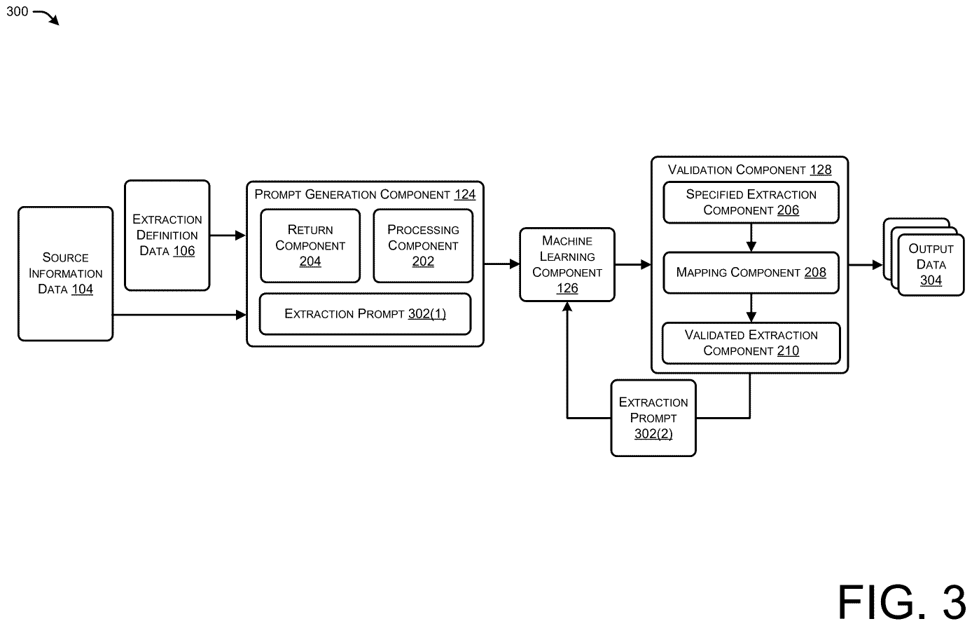

FIG. 3 illustrates an example process 300 for reiteratively extracting data from source information (e.g., source information data 104) for single data sets, according to at least some examples.

For example, a component of the extraction system (e.g., an extraction component of extraction system 120) may receive the extraction definition data 106. Additionally, or alternatively, the extraction system may receive source information data 104. Source information data 104 may include data associated with a document, PDF, webpage, messaging platforms, customer relationship management (CRM) platforms, audio data (e.g., live and/or recorded audio data), and/or the like. In some instances, the source information data 104 may be received via user input. Additionally, or alternatively, source information data 104 may be received via application programming interfaces (APIs) and API calls.

The extraction system may extract a data set according to the extraction definition data 106 upon receipt of source information data 104. Additionally, or alternatively, as described above, the extraction system may be configured to trigger the extraction of a data set based on one or more conditions. Based on the occurrence of a trigger event, the extraction system may be configured to extract a data set from source information data 104 according to the techniques described herein. For example, source information data 104 (e.g., a document in a digital format) may be received, detected, etc. by a component associated with the extraction system. The extraction definition data 106 may also be received by the extraction system or previously determined by the extraction system. In some instances, the extraction system may be configured to apply one or more transformations to the extraction definition data 106. For example, a processing component 202 of the extraction system may determine extraction processing instructions based on the extraction definition data 106. Additionally, or alternatively, a return component 204 of the extraction system may determine extraction return instructions based on the extraction definition data 106. As described above, the extraction definition data 106 may include natural language associated with one or more data fields (e.g., specifying data types, data format, data values, etc.). In some instances, the processing component 202 may determine a first representation of the extraction definition data 106 that may be usable by a machine learning component 126 of the extraction system. For example, the first representation of the extraction definition data 106 may include extraction processing instructions. The extraction processing instructions may include text-based instructions (e.g., what data to look for, how to format that data, calculations that need to be performed, value types, available tags, etc.) that are usable by the machine learning component 126 in order to extract information (e.g., and extracted data set) according to the extraction definition data 106. In some instances, determining the extraction processing instructions may include processing the extraction definition data 106 to JavaScript Object Notation (JSON), TypeScript schema, and/or other types of formats, programming languages, etc.

Additionally, or alternatively, the return component 204 may determine a second representation associated with the extraction definition data 106 that may be usable by the machine learning component 126 of the extraction system. For example, the second representation associated with the extraction definition data 106 may include extraction return instructions. The extraction return instructions may include text-based instructions (e.g., specifications such as the format, values, etc.) that are usable by the machine learning component 126 when outputting an extracted data set. In some instances, the extraction return instructions may instruct the machine learning component 126 to return the outputted data set in JSON, TypeScript, and/or other types of formats, programming languages, etc. Based on the extraction processing instructions and extraction return instructions, the prompt generation component 124 of the extraction system may be configured to determine an extraction prompt 302(1). For example, the extraction prompt 302(1) may include the extraction processing instructions, the extraction return instructions, source information data 104, and/or other instructions. The extraction prompt 302(1) may then be usable by the machine learning component 126 in order to extract a data set from the source information data 104 according to the extraction definition data 106. For example, based on the prompt, the machine learning component 126 may analyze the source information data 104 and extract data (e.g., an extracted data set) that corresponds to the extraction definition data 106 and/or extraction processing instructions. By way of example, and not limitation, an extraction definition data 106 may be configured to extract competitive intel (e.g., the store number associated with a competitor, price of a product, etc.) for source information data 104, such as a competitive pricing sheet. Based on the extraction prompt 302(1) generated from the extraction definition data 106, and including extraction processing instructions and/or extraction return instructions, the machine learning component 126 may execute an extraction of a data set, the data set including information corresponding to the competitive intel defined by the extraction definition data 106.

In some instances, the extraction system may be configured to perform one or more validation operations on the data set extracted by the machine learning component 126. For example, the extraction system may use, or work in combination with, a validation component 128 to perform validation operations. Validation operations may include validating the extracted data set to remove extraneous information (e.g., to determine a specified extracted data set), map the extracted data set to the extraction definition data 106 (e.g., to determine a mapped extracted data set), and/or validate the specified and mapped extracted data set to one or more requirements (e.g., to determine a validated extracted data set).

The specified extraction component 206 of the validation component 128 may determine a specified extracted data set by removing extraneous information from the extracted data set, such as invalid data. Invalid data that may be removed from an extracted data set may include data not pertaining to the extraction definition data 106, not in the valid format, etc. By way of example, and not limitation, the specified extraction component 206 may determine a specified extracted data set by removing invalid JSON formatting that may not correspond to the extraction definition data 106, such as removing from the extracted data set (e.g., a body of content) any information added by the machine learning component 126 (e.g., an introductory paragraph, extraneous comments, etc.). This way, a specified extracted data set may be determined. Additionally, or alternatively, the mapping component 208 of the validation component 128 may determine a mapped extracted data set from the specified extracted data set. The mapping component 208 may determine the mapped extracted data set by mapping the specified extracted data set to the extraction definition data 106 (e.g., using field identifiers). Additionally, or alternatively, the validated extraction component 210 of the validation component 128 may validate the mapped extracted data set to determine a validated extracted data set. The validated extraction component 210 may determine the validated extracted data set by determining a comparison between the mapped extracted data set and one or more attributes of the extraction definition data 106. For example, the validated extraction component 210 may determine whether the mapped extracted data set includes the data types, formats, values, etc. provided by the extraction definition data 106. By way of example, and not limitation, the extraction definition data 106 may include attributes such as an indication of a certain quantity of tags with pre-defined data values (e.g., tags of different competitors such as “Acme Corp.,” “XYZ Widget Co.,” and/or “Blackacre Holdings”). The validated extraction component 210 may then determine whether the mapped extracted data set in fact includes one of the data values defined by the extraction definition data 106.

Continuing from the example above, if the mapped extracted data set includes an indication of a competitor tag such as “Greenacre Holdings,” the mapped extracted data set may not be validated. In instances where a mapped extracted data set is not validated, the extraction system may be configured to discard the extracted data set, and perform one or more remedial actions (e.g., re-running the extraction, etc.). In instances where a mapped extracted data set is validated, the validation component 128 generates a validated extracted data set, which may be output by the extraction system (e.g., output data 304). The output data 304 (e.g., the validated extracted data set) may be displayed at a user interface, accessible via an API, stored locally and/or cloud-based, etc.

Additionally, or alternatively, the extraction system may be configured to determine whether additional data sets are present in the source information data 104. For example, as described above with respect to FIG. 2, the extraction system may be configured to extract, validate, and output a data set from source information data 104 and based on extraction definition data 106. However, in some instances, other similar information, or data sets, may extracted from the source information data and output as output data 304. By way of example, and not limitation, the source information data 104 may be representative of a pricing sheet containing multiple products and their related information (e.g., type of product, price, etc.), where the extraction definition data 106 is associated with a pricing data model. The validation component 128 of the extraction system may further be configured to determine whether there are additional data sets present in the source information data 104, and if so, generate an extraction prompt 302(2). In some instances, the extraction prompt 302(2) may be generated simultaneously to the extraction prompt 302(1). In this instance, the validation component 128 of the extraction system may be configured to determine whether there are additional data sets present in the source information data 104, and if so, use the generated extraction prompt 302(2). The validation component 128 may determine, from the source information data, constant information and dynamic information. For example, the validation component 128 may determine, from a pricing sheet, constant information such as the competitor and/or the store associated with the pricing sheet. The validation component 128 may also determine, from the pricing sheet, dynamic information such as the different products and their prices. Based on the information that would be dynamic with respect to a data set (e.g., the different products of the pricing sheet), extraction prompt 302(2) may be configured to instruct the machine learning component 126 to extract additional data sets for each of the products (e.g., if there were 20 products indicated in the pricing sheet, there are 20 data sets). The extraction system may be configured to generate multiple instances of the extraction definition data 106 (e.g., multiple instances of the pricing data model) for each of the products in the pricing sheet in order to generate output data 304 including multiple extraction outputs.

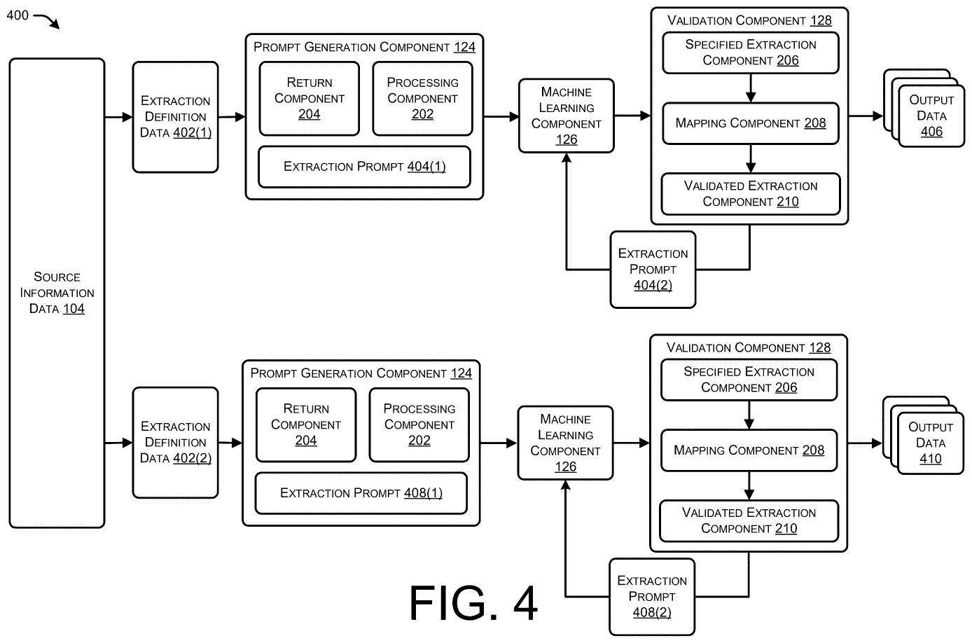

FIG. 4 illustrates an example process 400 for reiteratively extracting data from source information (e.g., source information data 104) for multiple data sets, according to at least some examples.

For example, as described above with respect to FIGS. 2 and 3, the extraction system may be configured to extract a single data set or perform multiple extractions of the single data set. Additionally, or alternatively, the extraction system may be configured to extract multiple data sets in addition to performing multiple extractions. For example, the extraction system may receive source information data 104. Additionally, or alternatively, the extraction system may receive extraction definition 402(1) and extraction definition 402(2). By way of example, and not limitation, the extraction definition 402(1) may be configured to extract information from the source information data 104 that is associated with product feedback. The extraction definition 402(2) may be configured to extract information from the source information data 104 that is associated with customer satisfaction. As described in more detail above, the extraction definition data 402(1) and extraction definition data 402(2) may similarly be transformed via processing components 202 and return components 204, and extraction prompt 404(1) and extraction prompt 404(2) may be generated by the prompt generation components 124. Further, and as described in more detail above, the machine learning components 126 and validation components 128 may similarly extract and validate data sets according to the extraction definition data 402(1) and extraction definition data 402(2).

Additionally, or alternatively, and as described above with respect to FIG. 3, the extraction system may be configured to determine whether additional data sets are present in the source information data 104 with respect to extraction definition data 402(1) and extraction definition data 402(2). Based on a determination of additional data sets, the validation components 128 may generate extraction prompt 404(2) and extraction prompt 404(2). In some instances, the extraction prompt 404(2) and/or 408(2) may be generated simultaneously to the extraction prompt 404(1) and/or 408(1). In this instance, the validation component 128 of the extraction system may be configured to determine whether there are additional data sets present in the source information data 104, and if so, use the generated extraction prompt 404(2) and/or 408(2). This way, the extraction system may generate output data 406 corresponding to extraction definition data 402(1) and source information data 104, as well as generate output data 410 corresponding to extraction definition data 402(2) and source information data 104.

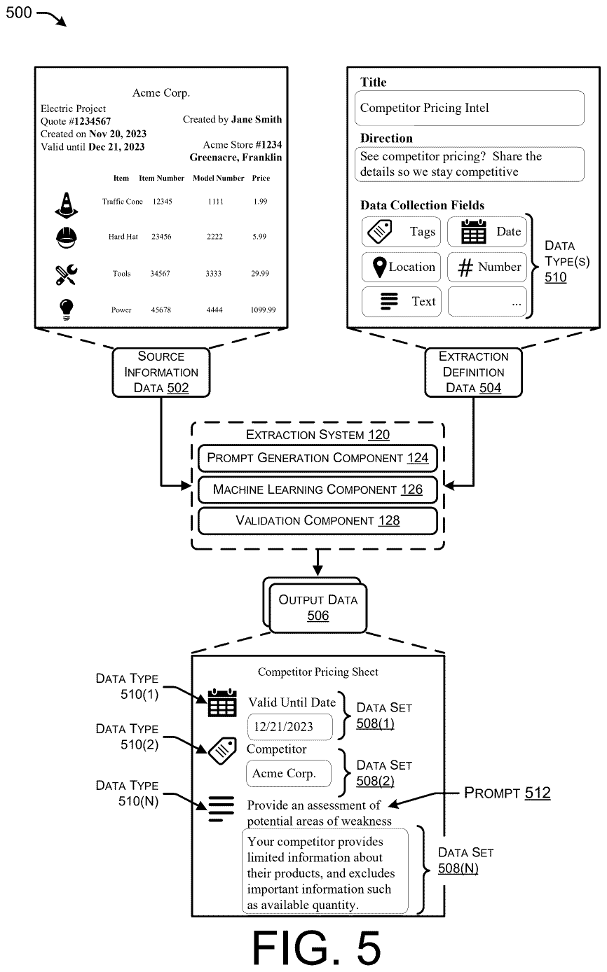

FIG. 5 illustrates an example process 500 and related user interfaces generating extraction definitions (e.g., extraction definition data 504) and the use thereof, according to at least some examples.

As described above, extraction system 120 may receive source information data, such as source information data 502 (which may correspond to source information data 104), and extraction definition data, such as extraction definition data 504 (which may correspond to extraction definition data 106). As illustrated, source information data 502 may correspond to a pricing sheet of a competitor (e.g., “Acme Corp.”) that lists pricing information for different products (e.g., traffic cone, hard hat, tools, and power). The extraction system 120 may also receive, or otherwise determine, extraction definition data 504. For example, extraction definition data 504 may include a data field, prompt, data type, data formats, data values, and/or the like. By way of example, a user may provide inputs associated with the extraction data model, such as a title, direction, and a selection of data type(s) 510. It is to be appreciated that the source information data 502 and extraction definition data 504 may be received simultaneously. Additionally, or alternatively, the extraction definition data 504 may indicate an extraction definition received and/or determined by the extraction system 120, and configured to be applied to incoming source information data 502.

As described above, based on extraction processing instructions and extraction return instructions, prompt generation component 124 of the extraction system 120 may be configured to determine an extraction prompt. The extraction prompt may then be usable by the machine learning component 126 in order to extract one or more data sets from the source information data 502 according to the extraction definition data 504. The extraction system 120 may also be configured to perform one or more validation operations on the data set extracted by the machine learning component 126. For example, the extraction system 120 may use, or work in combination with, a validation component 128 to perform validation operations. Validation operations may include validating the extracted data set to remove extraneous information (e.g., to determine a specified extracted data set), map the extracted data set to the extraction definition data 504 (e.g., to determine a mapped extracted data set), and/or validate the specified and mapped extracted data set to one or more requirements (e.g., to determine output data 506). As illustrated, output data 506 may include data sets 508(1), 508(2), and/or 508(N) (where “N” is any integer greater than one). The output data 506 may also include data types 510(1), 510(2), and/or 510(N) (where “N” is any integer greater than one). For example, data set 508(1) of the output data 506 (e.g., extracted data from the source information data 502 and based on extraction definition data 504) may indicate a date of “Dec. 21, 2023,” where the extraction definition data 504 included data type 510(1) (e.g., a date). In another example, data set 508(2) of the output data 506 may indicate an extracted competitor name, “Acme Corp.,” where the extraction definition data 504 included data type 510(2) (e.g., a tag). In another example, data set 508(N) of the output data 506 may indicate an analysis, determined by the extraction system 120, where the extraction definition data 504 included data type 510(N) (e.g., text) and is responsive to prompt 512. For example, prompt 512 may include instructions to “provide an assessment of potential areas of weakness” in a data field, where the extraction system 120 may determine that “your competitor provides limited information about their products, and excludes important information such as available quantity.”

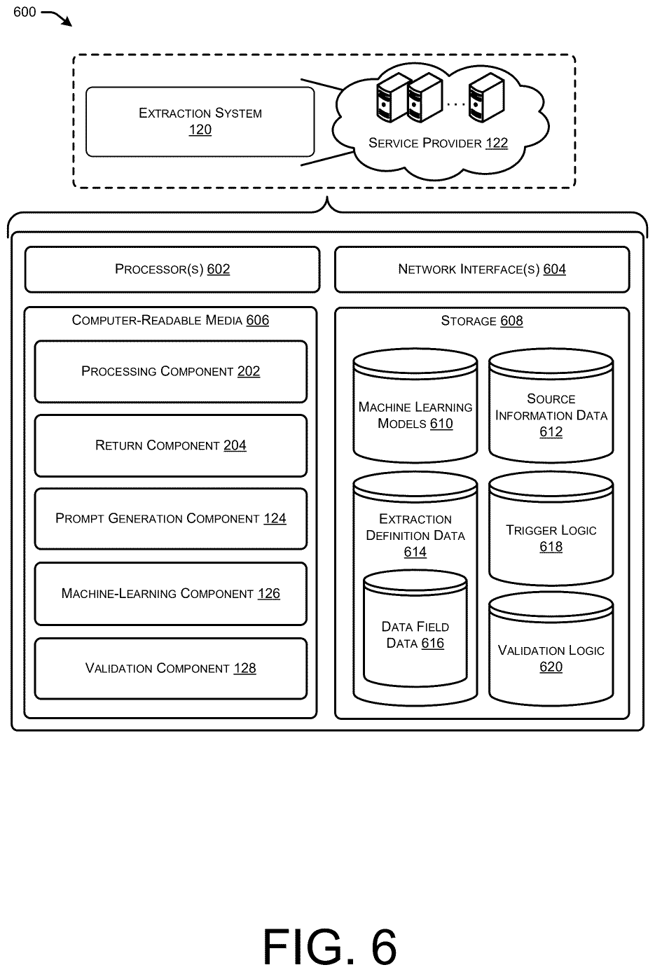

FIG. 6 illustrates example components 600 of the system of FIG. 1 (e.g., extraction system 120 of the service provider 122) that generates an extraction definition and processes source information, according to at least some examples. As illustrated, the extraction system 120 may include one or more hardware processor(s) 602 (processors) configured to execute one or more stored instructions. The processors 602 may comprise one or more cores.

Further, the extraction system 120 may include network interface(s) 604 to allow the processor 602 or other portions of the network of service provider 122 to communicate with other devices. The network interface(s) 604 may comprise Inter-Integrated Circuit (I2C), Serial Peripheral Interface bus (SPI), Universal Serial Bus (USB) as promulgated by the USB Implementers Forum, RS-232, and so forth. The network interface(s) 604 may include devices configured to couple to personal area networks (PANs), wired and wireless local area networks (LANs), wired and wireless wide area networks (WANs), and so forth. For example, the network interface(s) 604 may include devices compatible with Ethernet, Wi-Fi™, and so forth. Network interfaces 604 are representative of functionality to allow a user to enter commands and information to the extraction system 120, and also allow information to be presented to the user and/or other components or devices using various input/output devices. Examples of input devices include a keyboard, a cursor control device (e.g., a mouse), a scanner, touch functionality (e.g., capacitive or other sensors that are configured to detect physical touch), and so forth. Examples of output devices include a display device (e.g., a monitor or projector), speakers, a printer, a network card, tactile-response device, and so forth.

The extraction system 120 may also include computer-readable media 606 that stores various executable components (e.g., software-based components, firmware-based components, etc.). In addition to various components discussed in FIGS. 1-5, the computer-readable media 606 may further store components to implement functionality described herein. While not illustrated, the computer-readable media 606 may store one or more operating systems utilized to control the operation of the one or more devices that comprise the network of the service provider 122. The operating systems may implement a variant of the FreeBSD™ operating system as promulgated by the FreeBSD Project; other UNIX™ or UNIX-like variants; a variation of the Linux™ operating system as promulgated by Linus Torvalds; the Windows® Server operating system from Microsoft Corporation of Redmond, Washington, USA; and so forth. It should be appreciated that other operating systems can also be utilized.

The computer-readable media 606 may include portions, or components, that configure the extraction system 120 to perform various operations described herein. For example, the computer-readable media 606 may include a processing component 202 that configures the extraction system 120 to perform various operations described herein. For instance, the processing component 202 may be configured to, when executed by the processors 602, perform various techniques for determining extraction processing instructions (e.g., text-based instructions for subsequent processing by a machine learning model).

The computer-readable media 606 may include a return component 204 that configures the extraction system 120 to perform various operations described herein. For instance, the return component 204 may be configured to, when executed by the processors 602, perform various techniques for determining extraction return instructions (e.g., text-based instructions for returning the extracted data set from the source information and by the machine learning model).

The computer-readable media 606 may include a prompt generation component 124 that configures the extraction system 120 to perform various operations described herein. For instance, the prompt generation component 124 may be configured to, when executed by the processors 602, perform various techniques for determining and/or generating extraction prompts. For example, the prompt generation component 124 may utilize data, such as extraction definition data 106, to determine an extraction prompt including extraction processing instructions and/or extraction return instructions.

The computer-readable media 606 may further include a machine learning component 126 that configures the extraction system 120 to perform various operations described herein. For instance, the machine learning component 126 may be configured to, when executed by the processors 602, perform various techniques such as predictive analytic techniques, which may include, for example, predictive modelling, machine learning, and/or data mining. Generally, predictive modelling may utilize statistics to predict outcomes. Machine learning, while also utilizing statistical techniques, may provide the ability to improve outcome prediction performance without being explicitly programmed to do so. A number of machine learning techniques may be employed to generate and/or modify the models describes herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine learning.

The computer-readable media 606 may further include validation component 128 that configures the extraction system 120 to perform various operations described herein. For instance, the validation component 128 may be configured to, when executed by the processors 602 perform various techniques for validating an extracted data set. For example, the validation component 128 may utilize policies and/or rules to determine whether to validate an extracted data set. Additionally, or alternatively, the validation component 128 may utilize policies and/or rules to remove extraneous information (e.g., to determine a specified extracted data set), map the extracted data set to the extraction definition (e.g., to determine a mapped extracted data set), and/or validate the specified and mapped extracted data set to one or more requirements (e.g., to determine a validated extracted data set). Further, as illustrated in FIG. 2, the validation component 128 may include a specified extraction component 206, a mapping component 208, and/or a validated extraction component 210.

The above-noted list of components and their respective processes are merely exemplary, and other types of policies may be used to extract data sets from source information data.

Additionally, the extraction system 120 may include storage 608 which may comprise one, or multiple, repositories or other storage locations for persistently storing and managing collections of data such as databases, simple files, binary, and/or any other data. The storage 608 may include one or more storage locations that may be managed by one or more storage/database management systems. The storage 608 represents memory/storage capacity associated with one or more computer-readable media 606. The storage 608 may include volatile media (such as random access memory (RAM)) and/or nonvolatile media (such as read only memory (ROM), Flash memory, optical disks, magnetic disks, and so forth). The storage 608 may include fixed media (e.g., RAM, ROM, a fixed hard drive, and so on) as well as removable media (e.g., Flash memory, a removable hard drive, an optical disc, and so forth).

As illustrated, the storage 608 may include machine learning models 610, source information data 612, extraction definition data 614, data field data 616, trigger logic 618, and/or validation logic 620. It should be appreciated that the foregoing list is merely exemplary and the storage 608 may include additional elements that may be apparent to one skilled in the art.

The machine learning models 610 may include a database of machine learning models that are to be used by the machine learning component 126. The machine learning models 610 may include one or more algorithms including supervised, semi-supervised, unsupervised, and/or reinforcement. In some examples, the processor(s) 602 train(s) the extraction system 120 utilizing machine learning techniques, statistical analysis, or any other means by which a system may be trained to extract data sets from source information data and/or other data associated with storage 608.

Source information data 612 may include a database of source information such as a digital document (e.g., reports, transcripts, logs, notes, etc.), platform data (e.g., Customer Relationship Management (CRM) data), live audio data, recorded audio data, and/or the like. As such, source information data 612 may be used by the machine learning component 126 in order to extract data sets according to an extraction definition and/or extraction prompt from the prompt generation component 124. However, it is to be appreciated that not all source information data 612 is stored (e.g., processing user-provided text, URL, etc.).

Extraction definition data 614 may include a database of extraction definitions. Further, extraction definition data 614 may include data field data 616 comprising an extraction definition. For example, data field data 616 may include a database of data field attributes, such as prompts, data types, data formats, and/or the like. A data field may represent and/or store a particular attribute, property, characteristic, etc. to be extracted from source information data. A prompt may include a natural language explanation of the particular attribute, property, characteristics, etc. to be included as part of the data field. By way of example, and not limitation, a prompt may include and/or indicate competitive pricing terms, a price, issue date, competitor, strengths, weaknesses, product feedback, scores, etc. A data type associated with a data field may include the kind, or category, of information associated with the data field (e.g., tags, lists, tables, text, numbers, dates, and/or other information usable by the extraction system to determine how source information data should be processed or displayed). A data format associated with a data field may include a structure or presentation style associated with a data type (e.g., percentage, currency, date only, date and time, and/or the like). A data value associated with a data field may include a pre-defined value or set of values that may be included in a data field. For example, for a data field with a tag data type, the extraction definition may include data values such as explicitly-named competitor tags (e.g., “Acme Corp.,” “XYZ Widget Co.,” “Blackacre Holdings,” etc.).

The trigger logic 618 may include a database of logic for determining whether to trigger the use of an extraction definition for extracting data sets from source information data. For example, processing component 202, return component 204, and/or prompt generation component 124 may reference trigger logic 618 and/or source information data 612 in order to determine whether to trigger the use of the extraction definition. For example, triggers may include a particular term, key word, number, name, and/or the like. Additionally, or alternatively, triggers may include a specific value, combination of values, and/or other conditions (e.g., a value exceeding a threshold value). By way of example, and not limitation, an indication of competitor in a messaging channel (e.g., “Acme Corp”) may trigger the extraction of one or more data sets according to the extraction definition, where the source information data may at least partially include the contents of the messaging channel. In another example, the submission of PDF including a project bid over a particular value (e.g., $5,000) may trigger the extraction of one or more data sets according to the extraction definition, where the source information data may at least partially include the contents of the PDF. It is to be appreciated that the extraction system may be configured to trigger the use of multiple and/or different extraction definitions, as well as using multiples of and/or different source information data. In some instances, one or more triggers for different extraction definitions and/or source information data may occur simultaneously. Additionally, or alternatively, the extraction system may be configured to trigger the extraction of one or more data sets according to the extraction definition based on conditions such as a change in source information data, new source information data, etc. For example, source information data may indicate a new document in a particular folder (e.g., a watched folder), and in turn, trigger the extraction of one or more data sets according to the extraction definitions from the new document. It is to be appreciated that the triggering of data set extractions may be based on user input, API calls, machine learning, and/or the like.

The validation logic 620 may include a database of logic for determining whether to validate an extracted data set and generate an output. For example, the validation component 128 may reference validation logic 620 and/or extraction definition data 614 in determining whether to validate an extracted data set. Validation operations may include validating the extracted data set to remove extraneous information (e.g., to determine a specified extracted data set), map the extracted data set to the extraction definition (e.g., to determine a mapped extracted data set), and/or validate the specified and mapped extracted data set to one or more requirements (e.g., to determine a validated extracted data set).

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

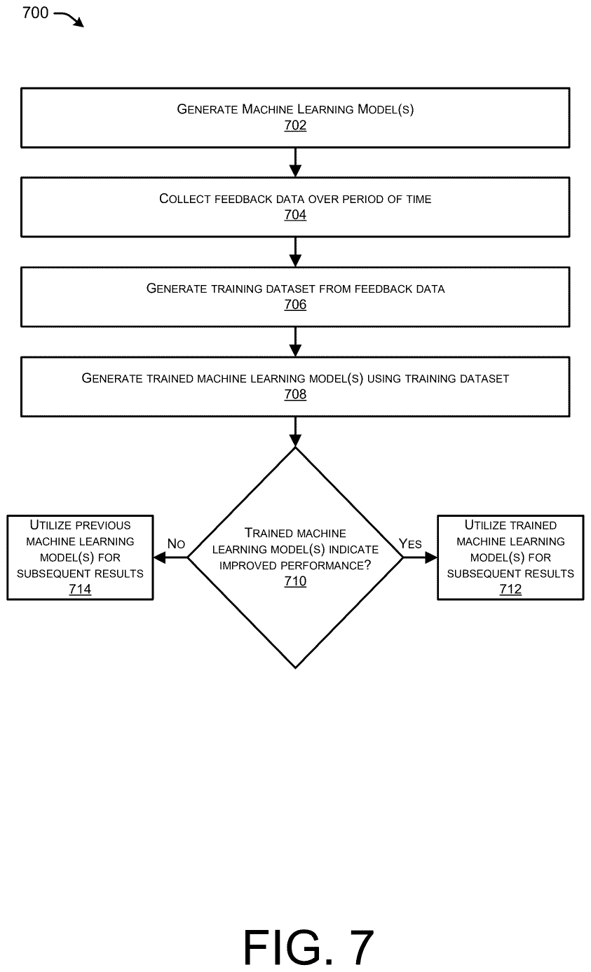

FIG. 7 illustrates example process 700 for the generation of a machine learning model and the use of the same. The order in which the operations or steps are described is not intended to be construed as a limitation, and any number of the described operations may be combined in any order and/or in parallel to implement process 700.

At block 702, the process 700 may include generating one or more artificial intelligence models, such as a machine learning model. A number of artificial intelligence techniques may be employed to generate and/or modify the layers and/or models described herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based artificial intelligence.

At block 704, the process 700 may include collecting feedback data over a period of time. The feedback data may include any data described with respect to FIGS. 1-6, or any other data that may be used to perform the operations described herein.

At block 706, the process 700 may include generating a training dataset from the feedback data. Generation of the training dataset may include formatting the feedback data into input vectors for the artificial intelligence model to intake.

At block 708, the process 700 may include generating one or more trained artificial intelligence models using the training dataset. Generation of the trained artificial intelligence models may include updating parameters and/or weightings and/or thresholds used by the models to generate extraction definitions and/or the use thereof.

At block 710, the process 700 may include determining whether the trained artificial intelligence models indicate improved performance metrics. For example, a testing group may be generated where extraction definitions and/or extraction output data associated with source information data are known, but not to the trained artificial intelligence models. The trained artificial intelligence models may generate results, which may be compared to the known results to determine whether the results of the trained artificial intelligence model produce a superior result than the results of the artificial intelligence model prior to training.

In examples where the trained artificial intelligence models indicate improved performance metrics, the process 700 may include, at block 712, using the trained artificial intelligence models for generating subsequent results. For example, the trained artificial intelligence models may be used to calibrate data set validation and the like. It should be understood that the trained artificial intelligence models may be used in any scenario where models are used as described herein.

In examples where the trained artificial intelligence models do not indicate improved performance metrics, the process 700 may include, at block 714, using the previous iteration of the artificial intelligence models for generating subsequent results.

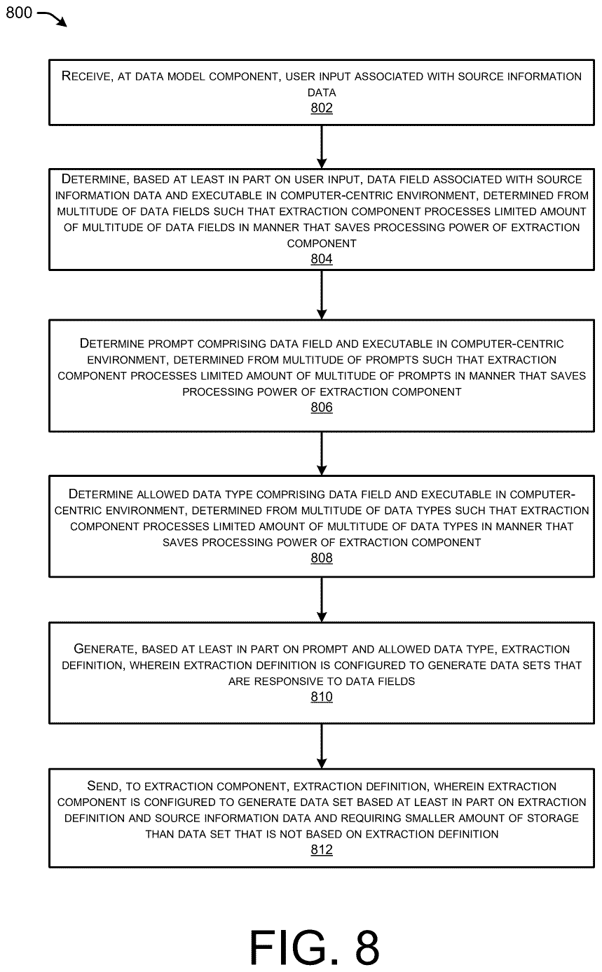

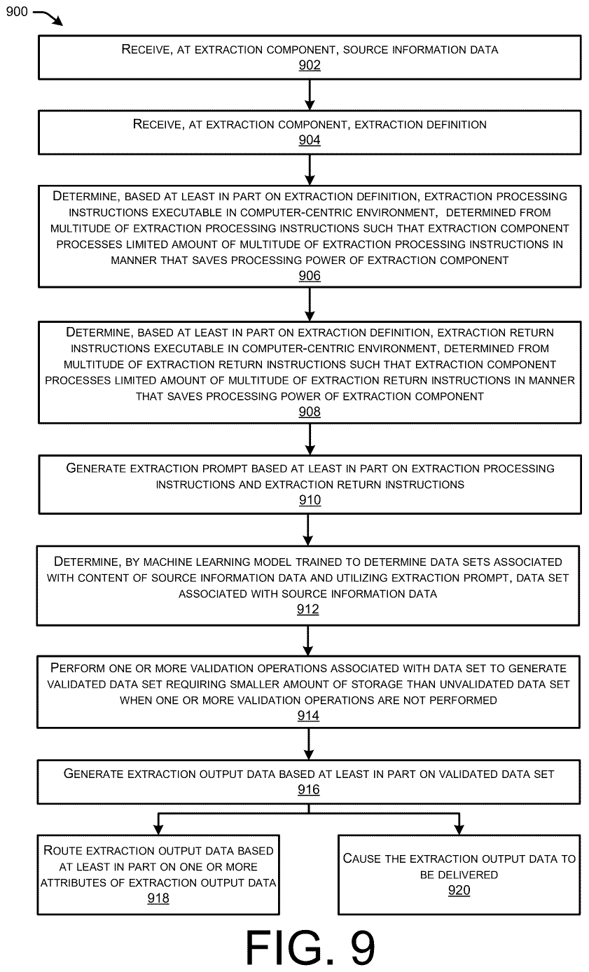

FIGS. 8 and 9 illustrate flowcharts outlining example methods, according to at least some examples. Various methods are described with reference to the example systems of FIGS. 1-7 for convenience and ease of understanding. However, the methods described are not limited to being performed by the example systems of FIGS. 1-7, and may be implemented using systems and devices other than those described herein.

The techniques may be applied by a system comprising one or more processors, and one or more non-transitory computer-readable media storing computer-executable instructions that, when executed by the one or more processors, cause the one or more processors to perform operations of method 800 and 900.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some examples, one or more operations of the methods may be omitted entirely. Moreover, the methods described herein can be combined in whole or in part with one another, and/or with other methods.

FIG. 8 illustrates a flowchart outlining an example method 800 for dynamic extraction definition generation for complex extractions, according to at least some examples.

At operation 802, the example method may include receiving, at a data model component, user input data associated with source information data. For example, a user of an extraction system may include an individual user, agent, business, corporation, entity, enterprise, and/or the like (collectively referred to as “entity”). For example, the entity may use the extraction system to gain insights from source information data. In some examples, the techniques described herein with respect to the extraction system may be performed, in part or entirely, by an artificial intelligence (AI) agent. In order to gain insights from source information data, the extraction system may use, or work in combination with, one or more components (e.g., a data model component) in order to determine the extraction definition. As described in more detail below, extraction definitions may include data fields including prompts and allowed, or pre-defined, data types, data values, etc. The extraction system may use, or work in combination with, the extraction definition in order to extract information, or one or more extracted data sets, from source information data.

At operation 804, the example method may include determining, based at least in part on the user input data, a data field associated with the source information data and executable in a computer-centric environment, the data field determined from a multitude of data fields such that an extraction component processes a limited amount of the multitude of data fields in a manner that saves processing power of the extraction component. For example, a data field may represent a container for particular information to be extracted and/or determined from source information data. Further, the data field may be executable in a computer-centric environment and determined from a multitude, or group, of data fields such that the extraction system (e.g., an extraction component) processes a limited amount of the group of data fields. This way, the extraction system may require the deployment of fewer computing resources (e.g., processing power) by processing a limited amount of the group of data fields.

At operation 806, the example method may include determining a prompt comprising the data field and executable in the computer-centric environment, the prompt determined from a multitude of prompts such that an extraction component processes a limited amount of the multitude of prompts in a manner that saves processing power of the extraction component. For example, a prompt may include a natural language explanation of the particular attribute, property, characteristics, etc. to be included as part of the data field. By way of example, and not limitation, a prompt associated with a data field may include a natural language explanation of the particular attribute, property, characteristics, etc. to be included as part of the data field. By way of example, and not limitation, a prompt may include and/or indicate competitive pricing terms, a price, issue date, competitor, strengths, weaknesses, product feedback, scores, etc. Further, the prompt may be executable in a computer-centric environment and determined from a multitude, or group, of prompts such that the extraction system processes a limited amount of the group of prompts. This way, the extraction system may require the deployment of fewer computing resources (e.g., processing power) by processing a limited amount of the group of prompts.

At operation 808, the example method may include determining an allowed data type comprising the data field and executable in the computer-centric environment, the prompt determined from a multitude of data fields such that an extraction component processes a limited amount of the multitude of data fields in a manner that saves processing power of the extraction component. For example, an allowed data type associated with a data field may include the kind, or type, of information that is allowed to populate the data field (e.g., tags, lists, tables, text, numbers, dates, and/or other information usable by the extraction system to determine how source information data should be processed, extracted from, etc.). Further, the data type may be executable in a computer-centric environment and determined from a multitude, or group, of data types such that the extraction system processes a limited amount of the group of data types. This way, the extraction system may require the deployment of fewer computing resources (e.g., processing power) by processing a limited amount of the group of data types.

At operation 810, the example method may include generating, based at least in part on the prompt and the allowed data type, an extraction definition, wherein the extraction definition is configured to generate data sets that are responsive to data fields. By way of example, and not limitation, an extraction definition may include a single data field with a prompt of “Competitive Pricing Terms” and a “text” data type. Additionally, or alternatively, an extraction definition may include multiple data fields. For example, the extraction definition may include a first data field with the prompt of “Competitive Pricing Terms” and a “text” data type, a second data field with the prompt of “Price” and a “number” data type, and/or a third data field with the prompt of “Competitor,” a “tag” data type, and an allowed data value (e.g., a tag corresponding to a competitor from a group of tagged competitors such as “Acme Corp. ,” “XYZ Widget Co. ,” “Blackacre Holdings,” etc.). An extraction definition may include any quantity of data fields. It is to be appreciated that the extraction definition may be usable to obtain objective information (e.g., pricing information) and/or subjective information (e.g., information on the strengths and weaknesses of source information data, such as a project proposal). By way of example, and not limitation, a data field with a text data type may include a prompt such as “review the proposal and identify the bidder's win themes. A win theme is described as the feature of capability the bidder has that allows them to solve the customer's issues. Describe the top five win themes in the proposal.”

In some instances, the extraction definition may be determined based on user input. User input data may indicate natural language instructions, a selection of allowed data types, data formats, data values, and/or the like. For example, user input data (e.g., from an administrator associated with an entity) may be received at a data model component and indicate instructions (e.g., selecting a competitor) associated with a data field, a selection of one or more allowed data types (e.g., tag field,), a selection of allowed data values, and/or the like. Based on the user input data, an extraction definition may be created that is configured to extract tailored and particular information from source information data.

Additionally, or alternatively, the extraction system may be configured to determine the extraction definition automatically (e.g., without user input, such as using an artificial intelligence (AI) agent). For example, the extraction system may use, or work in combination with, a machine learning component in order to determine which data fields, prompts, data types, and/or data values are to be included as part of an extraction definition (e.g., what is to be extracted). For example, a machine learning component may be configured to determine one or more attributes associated with the entity (e.g., best practices, guidelines, etc.). Based on the one or more attributes, the machine learning component may be configured to determine a comparison between the one or more attributes and a constructed data model (e.g., extraction definition). The comparison between the one or more attributes and the extraction definition may be used by the machine learning component to identify changes to extraction definition, a different extraction definition entirely, etc. For example, the machine learning component may determine a comparison between guidelines associated with the entity (e.g., what information the entity is focused on obtaining) and the extraction definition, and may identify changes to the extraction definition to better align with the guidelines. In some instances, the extraction system may use, or work in combination with, the machine learning component in order to determine which data fields, prompts, data types, and/or data values are to be included, or allowed, as part of the extraction definition based on source information data. For example, based on the source information data, the machine learning component may identify and/or determine key attributes (e.g., problems, feedback, etc.) associated with the source information data. Based on the key attributes associated with the source information data, an extraction definition may be determined (e.g., an extraction definition configured to extract and/or analyze information pertaining to the key attributes).

At operation 812, the example method may include sending, to the extraction component, the extraction definition, wherein the extraction component is configured to generate a data set based at least in part on the extraction definition and the source information data and requiring a smaller amount of storage than a data set that is not based on the extraction definition. For example, the extraction system may be configured to extract information (e.g., data sets) from source information data using the extraction definition described above. For example, a component of the extraction system (e.g., an extraction component) may receive the extraction definition. Additionally, or alternatively, the extraction system may receive source information data. Source information data may include, but is not limited to, data associated with a document, PDF, webpage, messaging platforms, customer relationship management (CRM) platforms, audio data (e.g., live and/or recorded audio data), communication data (e.g., unstructured conversation included in messages, emails, etc.), video data, text (e.g., handwritten, computer-generated, etc.) and/or the like. In some instances, the source information data may be received via user input. Additionally, or alternatively, source information data may be received via application programming interfaces (APIs) and API calls, and/or other means for pushing and/or pulling source information data.

The extraction system may extract one or more data sets according to the extraction definition upon receipt of source information data. This way, the extraction system may generate one or more data sets requiring a smaller amount of computing resources (e.g., storage) than data sets that are not based on an extraction definition.

Additionally, or alternatively, the example method 800 may include wherein the data field is a first data field, the prompt is a first prompt, and the allowed data type is a first allowed data type, the method further comprising determining, based at least in part on the user input data, a second data field associated with the source information data, determining a second prompt comprising the second data field, and determining a second allowed data type comprising the second data field, wherein generating the extraction definition is further based on the second prompt and the second allowed data type.

Additionally, or alternatively, the example method 800 may include wherein the prompt is a natural language prompt associated with the data field and indicating an attribute associated with the source information data.

Additionally, or alternatively, the example method 800 may include wherein the allowed data type comprises at least one of a tag, a list, a table, text, numbers, location, media, external records, customer relationship management (CRM), or dates.

Additionally, or alternatively, the example method 800 may include determining, based at least in part on the allowed data type, a data format associated with the allowed data type, wherein generating the extraction definition is further based at least in part on the data format.

Additionally, or alternatively, the example method 800 may include generating, based at least in part on the extraction definition, a machine learning model configured to determine the data fields associated with content of the source information data, and determining, based at least in part on the source information data and the machine learning model, the data fields associated with the content of the source information data.

Additionally, or alternatively, the example method 800 may include determining, at the extraction component, extraction processing instructions based at least in part on the extraction definition, determining, at the extraction component, extraction return instructions based at least in part on the extraction definition, generating, based at least in part on the extraction processing instructions and the extraction return instructions, an extraction prompt, and determining, based at least in part on the extraction prompt and the source information data, the data set.

FIG. 9 illustrates a flowchart outlining an example method 900 for complex extraction and analytics for content insights, according to at least some examples.

At operation 902, the example method may include receiving, at an extraction component, source information data. For example, source information data may include, but is not limited to, data associated with a document, PDF, webpage, messaging platforms, customer relationship management (CRM) platforms, audio data (e.g., live and/or recorded audio data), communication data (e.g., unstructured conversation included in messages, emails, etc.), video data, text (e.g., handwritten, computer-generated, etc.) and/or the like. In some instances, the source information data may be received via user input. Additionally, or alternatively, source information data may be received via application programming interfaces (APIs) and API calls, and/or other means for pushing and/or pulling source information data.

At operation 904, the example method may include receiving, at the extraction component, a first extraction definition. For example, the extraction definition may include a data field, prompt, data type, data formats, data values, and/or the like. A data field may represent a container for particular information to be extracted and/or determined from source information data. Further, the data field may be executable in a computer-centric environment and determined from a multitude, or group, of data fields such that the extraction system (e.g., an extraction component) processes a limited amount of the group of data fields. This way, the extraction system may require the deployment of fewer computing resources (e.g., processing power) by processing a limited amount of the group of data fields. A prompt associated with a data field may include a natural language explanation of the particular attribute, property, characteristics, etc. to be included as part of the data field. By way of example, and not limitation, a prompt may include and/or indicate competitive pricing terms, a price, issue date, competitor, strengths, weaknesses, product feedback, scores, etc. Further, the prompt may be executable in a computer-centric environment and determined from a multitude, or group, of prompts such that the extraction system processes a limited amount of the group of prompts. This way, the extraction system may require the deployment of fewer computing resources (e.g., processing power) by processing a limited amount of the group of prompts. A data type associated with a data field may include the kind, or type, of information that is allowed to populate the data field (e.g., tags, lists, tables, text, numbers, dates, and/or other information usable by the extraction system to determine how source information data should be processed, extracted from, etc.). Further, the data type may be executable in a computer-centric environment and determined from a multitude, or group, of data types such that the extraction system processes a limited amount of the group of data types. This way, the extraction system may require the deployment of fewer computing resources (e.g., processing power) by processing a limited amount of the group of data types. A data format associated with a data field may include a structure or presentation style associated with a data type that is permitted, or allowed, to populate the data field (e.g., percentage, currency, date only, date and time, and/or the like). An allowed data value associated with a data field may include a pre-defined value or set of values that may be included in a data field. For example, for a data field with a tag data type, the extraction definition may include allowed data values indicating that the data field is to include one of a set of defined competitor tag (e.g., “Acme Corp.,” “XYZ Widget Co.,” “Blackacre Holdings,” etc.).

By way of example, and not limitation, an extraction definition may include a single data field with a prompt of “Competitive Pricing Terms” and a “text” data type. Additionally, or alternatively, an extraction definition may include multiple data fields. For example, the extraction definition may include a first data field with the prompt of “Competitive Pricing Terms” and a “text” data type, a second data field with the prompt of “Price” and a “number” data type, and/or a third data field with the prompt of “Competitor,” a “tag” data type, and an allowed data value (e.g., a tag corresponding to a competitor from a group of tagged competitors such as “Acme Corp.,” “XYZ Widget Co.,” “Blackacre Holdings,” etc.). An extraction definition may include any quantity of data fields. It is to be appreciated that the extraction definition may be usable to obtain objective information (e.g., pricing information) and/or subjective information (e.g., information on the strengths and weaknesses of source information data, such as a project proposal). By way of example, and not limitation, a data field with a text data type may include a prompt such as “review the proposal and identify the bidder's win themes. A win theme is described as the feature of capability the bidder has that allows them to solve the customer's issues. Describe the top five win themes in the proposal.”

In some instances, the extraction definition may be determined based on user input. User input data may indicate natural language instructions, a selection of allowed data types, data formats, data values, and/or the like. For example, user input data (e.g., from an administrator associated with an entity) may be received at a data model component and indicate instructions (e.g., selecting a competitor) associated with a data field, a selection of one or more allowed data types (e.g., tag field,), a selection of allowed data values, and/or the like. Based on the user input data, an extraction definition may be created that is configured to extract tailored and particular information from source information data.

Additionally, or alternatively, the extraction system may be configured to determine the extraction definition automatically (e.g., without user input, such as using an artificial intelligence (AI) agent). For example, the extraction system may use, or work in combination with, a machine learning component in order to determine which data fields, prompts, data types, and/or data values are to be included as part of an extraction definition (e.g., what is to be extracted). For example, a machine learning component may be configured to determine one or more attributes associated with the entity (e.g., best practices, guidelines, etc.). Based on the one or more attributes, the machine learning component may be configured to determine a comparison between the one or more attributes and a constructed data model (e.g., extraction definition). The comparison between the one or more attributes and the extraction definition may be used by the machine learning component to identify changes to extraction definition, a different extraction definition entirely, etc. For example, the machine learning component may determine a comparison between guidelines associated with the entity (e.g., what information the entity is focused on obtaining) and the extraction definition, and may identify changes to the extraction definition to better align with the guidelines. In some instances, the extraction system may use, or work in combination with, the machine learning component in order to determine which data fields, prompts, data types, and/or data values are to be included, or allowed, as part of the extraction definition based on source information data. For example, based on the source information data, the machine learning component may identify and/or determine key attributes (e.g., problems, feedback, etc.) associated with the source information data. Based on the key attributes associated with the source information data, an extraction definition may be determined (e.g., an extraction definition configured to extract and/or analyze information pertaining to the key attributes).

The extraction system may be configured to extract information (e.g., data sets) from source information data using the extraction definition described above. For example, a component of the extraction system (e.g., an extraction component) may receive the extraction definition.

At operation 906, the example method may include determining, based at least in part on the first extraction definition, first extraction processing instructions executable in a computer-centric environment, the first extraction processing instructions determined from a multitude of extraction processing instructions such that the extraction component processes a limited amount of the multitude of extraction processing instructions in a manner that saves processing power of the extraction component. For example, the extraction system may be configured to apply one or more transformations to the extraction definition. For example, the extraction system may determine extraction processing instructions and/or extraction return instructions based on the extraction definition. The extraction processing instructions may be executable in a computer-centric environment, such as the computer-centric environment of the extraction system. For example, the extraction definition may include natural language associated with one or more data fields (e.g., specifying allowed data types, data format, allowed data values, etc.). In some instances, the extraction system may determine a first representation of the extraction definition that may be usable by a machine learning component of the extraction system. For example, the first representation of the extraction definition may include extraction processing instructions. The extraction processing instructions may include text-based instructions (e.g., what data to look for, how to format that data, calculations that need to be performed, value types, available tags, etc.) that are usable by the machine learning component in order to extract information (e.g., extracted data sets) according to the extraction definition. In some instances, determining the extraction processing instructions may include processing the extraction definition to JavaScript Object Notation (JSON), TypeScript schema, and/or other types of formats, programming languages, etc. Additionally, or alternatively, the extraction system may determine the extraction processing instructions from a multitude, or group, of extraction processing instructions. By way of example, and not limitation, the group of extraction processing instructions may each be associated with text-based instructions associated with different extraction definitions (e.g., extraction processing instructions for extracting different data types, data formats, data values, etc.). This way, the extraction system may require the deployment of fewer computing resources (e.g., processing power) by processing a limited amount of the group of extraction processing instructions.

At operation 908, the example method may include determining, based at least in part on the first extraction definition, first extraction return instructions executable in the computer-centric environment, the first extraction return instructions determined from a multitude of extraction return instructions such that the extraction component processes a limited amount of the multitude of extraction return instructions in a manner that saves processing power of the extraction component. For example, the extraction system may determine a second representation associated with the extraction definition that may be usable by the machine learning component of the extraction system. For example, the second representation associated with the extraction definition may include extraction return instructions. For example, the extraction system may determine extraction processing instructions and/or extraction return instructions based on the extraction definition. The extraction processing instructions may be executable in a computer-centric environment, such as the computer-centric environment of the extraction system. The extraction return instructions may include text-based instructions (e.g., specifications such as the format, values, etc.) that are usable by the machine learning component when outputting an extracted data set. In some instances, the extraction return instructions may instruct the machine learning component to return the outputted data set in JSON, TypeScript, and/or other types of formats, programming languages, etc. Additionally, or alternatively, the extraction system may determine the extraction return instructions from a multitude, or group, of extraction return instructions. By way of example, and not limitation, the group of extraction return instructions may each be associated with text-based instructions associated with different extraction definitions (e.g., extraction return instructions for outputting different data types, data formats, data values, etc.). This way, the extraction system may require the deployment of fewer computing resources (e.g., processing power) by processing a limited amount of the group of extraction return instructions.

At operation 910, the example method may include generating an extraction prompt based at least in part on the first extraction processing instructions and the first extraction return instructions. For example, based on the extraction processing instructions and/or extraction return instructions, the extraction system may be configured to determine an extraction prompt. For example, the extraction prompt may include the extraction processing instructions, the extraction return instructions, source information data, and/or other instructions. The extraction prompt may then be usable by the machine learning component in order to extract one or more data sets from the source information data according to the extraction definition.

At operation 912, the example method may include by a machine learning model trained to determine data sets associated with content of the source information data and utilizing the extraction prompt, a data set associated with the source information data. For example, based on the prompt, the machine learning component may analyze the source information data and extract data (e.g., an extracted data set) that corresponds to the extraction definition and/or extraction processing instructions (e.g., populates the defined data field). By way of example, and not limitation, an extraction definition may be configured to extract competitive intel (e.g., the store number associated with a competitor, price of a product, etc.) for source information data, such as a competitive pricing sheet. Based on the extraction prompt generated from the extraction definition, and including extraction processing instructions and/or extraction return instructions, the machine learning component may execute an extraction of a data set, the data set including information corresponding to the competitive intel defined by the extraction definition. In some instances, the machine learning component may be configured to execute the extraction of a data set that only partially corresponds to the extraction definition. By way of example, and not limitation, the machine learning component may otherwise “leave blank” certain data fields (e.g., refrain from populating a defined data field). In other words, the machine learning component may refrain from including a portion of the source information data as corresponding to a data field defined by the extraction definition in instances where the machine learning component is uncertain about the data to extract according to the extraction definition. For example, the machine learning component may determine a confidence associated with one or more portions of the extracted data set. If the confidence is below a confidence threshold, the machine learning component may refrain from including one or more portions of the source information data as corresponding to a respective data field. Additionally, or alternatively, the machine learning component may “leave blank” certain data fields when there is no match between the source information data and the extraction definition (e.g., between the source information data and one or more data fields of the extraction definition). By way of example, and not limitation, there may be no match between the source information data and an allowed data type for a data field of an extraction definition.

At operation 914, the example method may include performing one or more validation operations associated with the data set to generate a validated data set requiring a smaller amount of storage than an unvalidated data set when the one or more validation operations are not performed. For example, the extraction system may use, or work in combination with, a validation component to perform validation operations. Validation operations may include validating the extracted data set to remove extraneous information (e.g., to determine a specified extracted data set), map the extracted data set to the extraction definition (e.g., to determine a mapped extracted data set), and/or validate the specified and mapped extracted data set to one or more requirements (e.g., to determine a validated extracted data set).

The validation component may determine a specified extracted data set by removing extraneous information from the extracted data set, such as invalid data. Invalid data that may be removed from an extracted data set may include data not pertaining to the extraction definition, not an allowed data type, data format, data value, etc. By way of example, and not limitation, the validation component may determine a specified extracted data set by removing invalid JSON formatting that may not correspond to the extraction definition, such as removing from the extracted data set (e.g., a body of content) any information added by the machine learning component (e.g., an introductory paragraph, extraneous comments, etc.). This way, a specified extracted data set may be determined. Additionally, or alternatively, the validation component may determine a mapped extracted data set from the specified extracted data set. The validation component may determine the mapped extracted data set by mapping the specified extracted data set to the extraction definition (e.g., using field identifiers). Additionally, or alternatively, the validation component may validate the mapped extracted data set to determine a validated extracted data set. The validation component may determine the validated extracted data set by determining a comparison between the mapped extracted data set and one or more attributes of the extraction definition. For example, the validation component may determine whether the mapped extracted data set includes the allowed data types, formats, values, etc. defined by the extraction definition. By way of example, and not limitation, the extraction definition may include attributes such as an indication of a certain quantity of tags with allowed, or pre-defined, data values (e.g., tags indicating a competitor such as “Acme Corp.,” “XYZ Widget Co.,” and/or “Blackacre Holdings”). The validation component may then determine whether the mapped extracted data set in fact includes one of the allowed data values defined by the extraction definition.

Continuing from the example above, if the mapped extracted data set includes an indication of a competitor tag such as “Greenacre Holdings,” the mapped extracted data set may not be validated. In instances where a mapped extracted data set is not validated, the extraction system may be configured to discard the extracted data set, and perform one or more remedial actions (e.g., re-running the extraction, etc.). In instances where a mapped extracted data set is validated, the validation component generates a validated extracted data set, which may be output by the extraction system. By generating and/or using the validated extracted data set, the extraction system may require the deployment of fewer computing resources (e.g., storage) by outputting only the validated extracted data set as opposed to an unvalidated data set.

At operation 916, the example method may include generating extraction output data based at least in part on the validated data set. For example, in instances where a mapped extracted data set is validated, the validation component generates a validated extracted data set, which may be output by the extraction system.

At operation 918, the example method may include routing the extraction output data based at least in part on one or more attributes of the extraction output data. For example, the output data (e.g., the validated extracted data set) may be routed by the extraction system based on one or more attributes of the output data. For example, the extraction system may determine one or more attributes of the output data (e.g., the amount of output data, the type of output data, the subject matter of the output data, the source information data from which the output data was determined, etc.). Based on the one or more attributes of the output data may be routed such that the output data may be displayed at a user interface, accessible via an API, stored locally and/or cloud-based, etc. In some instances, based on the one or more attributes of the output data, the output data may be routed to a user associated with the source information data and/or extraction definition data. Additionally, or alternatively, the extraction system may be configured to output the validated extracted data set to particular users, systems, etc. based on the one or more attributes of the output data. For example, the validated extracted data set may include an indication of escalated data for the entity (e.g., an indication that a product of the entity is defective, causing harm, etc.). Based on this indication, the extraction system may determine that the validated extracted data set should be escalated to a particular user, system, etc. (e.g., the head of product development), and output the validated extracted data set accordingly.

At operation 920, the example method may include causing the extraction output data to be delivered. For example, in some instances, the extraction system may be configured to output the validated extracted data set, and return the validated extracted data set to a user (e.g., a user who requested the validated extracted data set).

Additionally, or alternatively, the example method 900 may include, wherein the extraction prompt is a first extraction prompt, and the data set is a first data set, determining, based at least in part on the first extraction prompt, additional data sets associated with the source information data, generating a second extraction prompt based at least in part on the additional data sets, determining, by the machine learning model trained to determine data sets associated with content of the source information data and utilizing the second extraction prompt, a second data set, and performing one or more validation operations associated with the second data set to generate a validated second data set requiring a smaller amount of storage than an unvalidated data set when the one or more validation operations are not performed, wherein generating the extraction output data is further based at least in part on the validated second data set.

Additionally, or alternatively, the example method 900 may include, wherein the data set comprises a first data set type, and the extraction output data is first extraction output data, receiving, at the extraction component, a second extraction definition, determining, based at least in part on the second extraction definition, second extraction processing instructions executable in the computer-centric environment, the second extraction processing instructions determined from the multitude of extraction processing instructions such that the extraction component processes the limited amount of the multitude of extraction processing instructions in a manner that saves the processing power of the extraction component, determining, based at least in part on the second extraction definition, second extraction return instructions executable in the computer-centric environment, the second extraction return instructions determined from the multitude of extraction return instructions such that the extraction component processes the limited amount of the multitude of extraction return instructions in the manner that saves the processing power of the extraction component, generating a second extraction prompt based at least in part on the second extraction processing instructions and the second extraction return instructions, determining, by the machine learning model trained to determine data sets associated with content of the source information data and utilizing the second extraction prompt, a third data set, wherein the third data set comprises a second data set type that is different than the first data set type, performing one or more validation operations associated with the third data set to generate a validated third data set requiring a smaller amount of storage than an unvalidated data set when the one or more validation operations are not performed, generating second extraction output data based at least in part on the validated third data set, and routing the second extraction output data based at least in part on one or more attributes of the second extraction output data

Additionally, or alternatively, the example method 900 may include, wherein performing the one or more validation operations associated with the data set comprises determining a first portion of the data set and a second portion of the data set, removing the second portion of the data set, determining a mapping between the first portion of the data set and the first extraction definition to generate a mapped data set, and validating the mapped data set to generate the validated data set.

Additionally, or alternatively, the example method 900 may include, wherein validating the mapped data set to generate the validated data set further comprises determining a first allowed data type associated with mapped data set, determining a second allowed data type associated with the first extraction definition, determining whether the first allowed data type corresponds to the second allowed data type, and based at least in part on the first allowed data type corresponding to the second allowed data type, validating the mapped data set to generate the validated data set, or based at least in part on the first allowed data type not corresponding to the second allowed data type, refraining from validating the mapped data set.

Additionally, or alternatively, the example method 900 may include, wherein determining, by the machine learning model and the extraction prompt, the data set further comprises generating, based at least in part on the extraction prompt, the machine learning model trained to determine data sets associated with content of the source information data, and determining, based at least in part on the source information data and the machine learning model, the data set.

Additionally, or alternatively, the example method 900 may include, wherein the source information data is first source information data, further comprises receiving, at the extraction component, second source information data, determining, by the machine learning model trained to determine data sets associated with content of the source information data and utilizing the extraction prompt, a second data set associated with the second source information data, and performing one or more validation operations associated with the second data set to generate a validated second data set requiring a smaller amount of storage than an unvalidated data set when the one or more validation operations are not performed, wherein generating the extraction output data is further based at least in part on the validated second data set.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.” As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, at a data model component, user input data associated with source information data;
determining, based at least in part on the user input data, a data field associated with the source information data and executable in a computer-centric environment, the data field determined from a multitude of data fields such that an extraction component processes a limited amount of the multitude of data fields in a manner that saves processing power of the extraction component;
determining a prompt comprising the data field and executable in the computer-centric environment, the prompt determined from a multitude of prompts such that an extraction component processes a limited amount of the multitude of prompts in a manner that saves processing power of the extraction component;
determining an allowed data type comprising the data field and executable in the computer-centric environment, the prompt determined from a multitude of data fields such that an extraction component processes a limited amount of the multitude of data fields in a manner that saves processing power of the extraction component;
generating, based at least in part on the prompt and the allowed data type, an extraction definition, wherein the extraction definition is configured to generate data sets that are responsive to data fields; and
sending, to the extraction component, the extraction definition, wherein the extraction component is configured to generate a data set based at least in part on the extraction definition and the source information data and requiring a smaller amount of storage than a data set that is not based on the extraction definition.

2. The method of claim 1, wherein the data field is a first data field, the prompt is a first prompt, and the allowed data type is a first allowed data type, the method further comprising:
determining, based at least in part on the user input data, a second data field associated with the source information data and executable in the computer-centric environment, the second data field determined from the multitude of data fields such that the extraction component processes the limited amount of the multitude of data fields in a manner that saves processing power of the extraction component;
determining a second prompt comprising the second data field and executable in the computer-centric environment, the second prompt determined from the multitude of prompts such that the extraction component processes the limited amount of the multitude of prompts in a manner that saves processing power of the extraction component; and
determining a second allowed data type comprising the second data field and executable in the computer-centric environment, the second data field determined from the multitude of data fields such that the extraction component processes the limited amount of the multitude of data fields in a manner that saves processing power of the extraction component, wherein generating the extraction definition is further based on the second prompt and the second allowed data type.

3. The method of claim 1, wherein the prompt is a natural language prompt associated with the data field and indicating an attribute associated with the source information data.

4. The method of claim 1, wherein the allowed data type comprises at least one of a tag, a list, a table, text, numbers, location, media, external records, customer relationship management (CRM), or dates.

5. The method of claim 1, further comprising determining, based at least in part on the allowed data type, a data format associated with the allowed data type, wherein generating the extraction definition is further based at least in part on the data format.

6. The method of claim 1, further comprising:
generating, based at least in part on the extraction definition, a machine learning model configured to determine the data fields associated with content of the source information data; and
determining, based at least in part on the source information data and the machine learning model, the data fields associated with the content of the source information data.

7. The method of claim 1, further comprising:
determining, at the extraction component, extraction processing instructions based at least in part on the extraction definition;
determining, at the extraction component, extraction return instructions based at least in part on the extraction definition;
generating, based at least in part on the extraction processing instructions and the extraction return instructions, an extraction prompt; and
determining, based at least in part on the extraction prompt and the source information data, the data set.

8. A system comprising:
one or more processors; and
one or more computer-readable media storing instructions that, when executed by the one or more processors, cause the one or more processors to perform operations comprising:
receiving, at a data model component, user input data associated with source information data;
determining, based at least in part on the user input data, a data field associated with the source information data and executable in a computer-centric environment, the data field determined from a multitude of data fields such that an extraction component processes a limited amount of the multitude of data fields in a manner that saves processing power of the extraction component;
determining a prompt comprising the data field and executable in the computer-centric environment, the prompt determined from a multitude of prompts such that an extraction component processes a limited amount of the multitude of prompts in a manner that saves processing power of the extraction component;
determining an allowed data type comprising the data field and executable in the computer-centric environment, the prompt determined from a multitude of data fields such that an extraction component processes a limited amount of the multitude of data fields in a manner that saves processing power of the extraction component;
generating, based at least in part on the prompt and the allowed data type, an extraction definition, wherein the extraction definition is configured to generate data sets that are responsive to data fields; and
sending, to the extraction component, the extraction definition, wherein the extraction component is configured to generate a data set based at least in part on the extraction definition and the source information data the extraction definition, wherein the extraction component is configured to generate a data set based at least in part on the extraction definition and the source information data and requiring a smaller amount of storage than a data set that is not based on the extraction definition.

9. The system of claim 8, wherein the data field is a first data field, the prompt is a first prompt, and the allowed data type is a first allowed data type, the operations further comprising:
determining, based at least in part on the user input data, a second data field associated with the source information data and executable in the computer-centric environment, the second data field determined from the multitude of data fields such that the extraction component processes the limited amount of the multitude of data fields in a manner that saves processing power of the extraction component;
determining a second prompt comprising the second data field and executable in the computer-centric environment, the second prompt determined from the multitude of prompts such that the extraction component processes the limited amount of the multitude of prompts in a manner that saves processing power of the extraction component; and
determining a second allowed data type comprising the second data field and executable in the computer-centric environment, the second data field determined from the multitude of data fields such that the extraction component processes the limited amount of the multitude of data fields in a manner that saves processing power of the extraction component, wherein generating the extraction definition is further based on the second prompt and the second allowed data type.

10. The system of claim 8, wherein the prompt is a natural language prompt associated with the data field and indicating an attribute associated with the source information data.

11. The system of claim 8, wherein the allowed data type comprises at least one of a tag, a list, a table, text, numbers, location, media, external records, customer relationship management (CRM), or dates.

12. The system of claim 8, further comprising determining, based at least in part on the allowed data type, a data format associated with the allowed data type, wherein generating the extraction definition is further based at least in part on the data format.

13. The system of claim 8, the operations further comprising:
generating, based at least in part on the extraction definition, a machine learning model configured to determine the data fields associated with content of the source information data; and
determining, based at least in part on the source information data and the machine learning model, the data fields associated with the content of the source information data.

14. The system of claim 8, the operations further comprising:
determining, at the extraction component, extraction processing instructions based at least in part on the extraction definition;
determining, at the extraction component, extraction return instructions based at least in part on the extraction definition;
generating, based at least in part on the extraction processing instructions and the extraction return instructions, an extraction prompt; and
determining, based at least in part on the extraction prompt and the source information data, the data set.

15. A non-transitory computer-readable medium storing having instructions stored thereon that, when executed by one or more processors, cause the one or more processors to perform operations comprising:
receiving, at a data model component, user input data associated with source information data;
determining, based at least in part on the user input data, a data field associated with the source information data and executable in a computer-centric environment, the data field determined from a multitude of data fields such that an extraction component processes a limited amount of the multitude of data fields in a manner that saves processing power of the extraction component;
determining a prompt comprising the data field and executable in the computer-centric environment, the prompt determined from a multitude of prompts such that an extraction component processes a limited amount of the multitude of prompts in a manner that saves processing power of the extraction component;
determining an allowed data type comprising the data field and executable in the computer-centric environment, the prompt determined from a multitude of data fields such that an extraction component processes a limited amount of the multitude of data fields in a manner that saves processing power of the extraction component;
generating, based at least in part on the prompt and the allowed data type, an extraction definition, wherein the extraction definition is configured to generate data sets that are responsive to data fields; and
sending, to the extraction component, the extraction definition, wherein the extraction component is configured to generate a data set based at least in part on the extraction definition and the source information data and requiring a smaller amount of storage than a data set that is not based on the extraction definition.

16. The non-transitory computer-readable medium of claim 15, wherein the data field is a first data field, the prompt is a first prompt, and the allowed data type is a first allowed data type, the operations further comprising:
determining, based at least in part on the user input data, a second data field associated with the source information data and executable in the computer-centric environment, the second data field determined from the multitude of data fields such that the extraction component processes the limited amount of the multitude of data fields in a manner that saves processing power of the extraction component;
determining a second prompt comprising the second data field and executable in the computer-centric environment, the second prompt determined from the multitude of prompts such that the extraction component processes the limited amount of the multitude of prompts in a manner that saves processing power of the extraction component; and
determining a second allowed data type comprising the second data field and executable in the computer-centric environment, the second data field determined from the multitude of data fields such that the extraction component processes the limited amount of the multitude of data fields in a manner that saves processing power of the extraction component, wherein generating the extraction definition is further based on the second prompt and the second allowed data type.

17. The non-transitory computer-readable medium of claim 15, wherein the allowed data type comprises at least one of a tag, a list, a table, text, numbers, location, media, external records, customer relationship management (CRM), or dates.

18. The non-transitory computer-readable medium of claim 15, further comprising determining, based at least in part on the allowed data type, a data format associated with the allowed data type, wherein generating the extraction definition is further based at least in part on the data format.

19. The non-transitory computer-readable medium of claim 15, the operations further comprising:
generating, based at least in part on the extraction definition, a machine learning model configured to determine the data fields associated with content of the source information data; and
determining, based at least in part on the source information data and the machine learning model, the data fields associated with the content of the source information data.

20. The non-transitory computer-readable medium of claim 15, the operations further comprising:
determining, at the extraction component, extraction processing instructions based at least in part on the extraction definition;
determining, at the extraction component, extraction return instructions based at least in part on the extraction definition;
generating, based at least in part on the extraction processing instructions and the extraction return instructions, an extraction prompt; and
determining, based at least in part on the extraction prompt and the source information data, the data set.
